(19) United States
(12) Patent Application Publication
(10) Pub. No.: US 2019/0354602 A1
(43) Pub. Date: Nov. 21, 2019

(54) DYNAMICALLY CHANGING THE ARCHITECTURE OF A DATASET WHILE ALLOWING CONCURRENT USER ACCESS TO DATA IN THE DATASET

(71) Applicant: CA, Inc., Islandia, NY (US)

(72) Inventors: Kevin P. Shuma, Celina, TX (US); Joseph B. Lynn, Plano, TX (US); Kenneth W. Eaton, Terrell, TX (US)

(73) Assignee: CA, Inc., Islandia, NY (US)

(21) Appl. No.: 15/983,560

(22) Filed: May 18, 2018

(51) Int. Cl. G06F 17/30

(52) U.S. Cl. CPC G06F 17/30082; G06F 17/30079

(57) ABSTRACT

An embodiment includes initiating a first migration of data rows in a source dataset in a source storage device to a target dataset in a target storage device, wherein a block size defined for the target dataset is different than a block size defined for the source dataset. The embodiment also includes, during the first migration, receiving a user request for access to a first data row in the source dataset, determining that the first data row was migrated to a first target block in the target dataset, loading the first target block from the target dataset into a first buffer in memory, and responding to the user request using the first data row in the first target block. In specific embodiments a device type that defines the source storage device is different than a device type that defines the target storage device.

### BACKGROUND

The present disclosure relates in general to the field of data storage, and more specifically, to dynamically changing the architecture of a dataset while allowing concurrent user access to data in the dataset.

Mass storage devices (MSDs) are used to store large quantities of data. A wide variety of entities utilize MSDs to enable continuous or near-continuous access to the data. Retailers, government agencies and services, educational institutions, transportation services, and health care organizations are among a few entities that may provide ‘always on’ access to their data by customers, employees, students, or other authorized users.

A database is one example of a data structure used to store large quantities of data as an organized collection of information. Typically, databases have a logical structure such that a user accessing the data in the database sees logical data columns arranged in logical data rows. A Database Administrator (DBA) typically uses current technology to architect a database for a given entity. While the initial architecture may provide resources and expansion capabilities, technology advances may render the initial architecture comparatively inefficient and expensive. To exploit new data storage technology, however, a change in the architecture is often needed. For some entities, reconstructing the architecture and migrating old datasets to the newly constructed datasets requires significant downtime in which the database is ‘off-line’ and unavailable to users. In many scenarios, this downtime may not be acceptable.

### BRIEF SUMMARY

According to one aspect of the present disclosure, a first migration of data rows in a source dataset in a source storage device to a target dataset in a target storage device is initiated. A block size defined for the target dataset can be different than a block size defined for the source dataset. Buffers in memory are available to handle both the source and target block size. During the first migration, a user request for access to a first data row in the source dataset can be received. A determination can be made that the first data row was migrated to a first target block in the target dataset. The first target block can be loaded from the target dataset into a first buffer in memory. A response to the user request can be made using the first data row in the first target block loaded into the first buffer.

### BRIEF DESCRIPTION OF THE DRAWINGS

FIG. 1 is a simplified block diagram of an example of some components of a communication system for dynamically changing the architecture of a dataset, while allowing concurrent user access to data in the dataset, according to at least one embodiment of the present disclosure;

FIG. 2 is a simplified block diagram illustrating additional details of certain components of the communication system according to at least one embodiment;

FIGS. 3A-3K are block diagrams illustrating an example scenario of the communication system in which the architecture of a dataset is dynamically changed according to at least one embodiment;

FIGS. 4A-4B are simplified flowcharts related to dynamically changing the architecture of a source dataset to a target dataset according to at least one embodiment;

FIGS. 5A-5B are simplified flowcharts related to migrating data rows from a source dataset to a target dataset in the communication system according to at least one embodiment;

FIG. 6 is a simplified flow diagram related to user requests for access to data rows in datasets in the communication system according to at least one embodiment;

FIGS. 7A-7B are simplified flowcharts related to managing user requests to access a dataset during a migration of the dataset in the communication system according to at least one embodiment;

FIG. 8 is a simplified flowchart related to managing user requests to modify a dataset during a migration of the dataset in the communication system according to at least one embodiment;

FIG. 9 is a simplified flowchart related to managing user requests to add a data row to a dataset during a migration of the dataset in the communication system according to at least one embodiment;

FIG. 10 is a simplified flowchart related to managing a utility process request during a migration of a dataset in the communication system according to at least one embodiment; and

FIG. 11 is a simplified flowchart related to pausing a migration process in the communication system according to at least one embodiment.

Like reference numbers and designations in the various drawings indicate like elements.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely software (including firmware, resident software, micro-code, etc.) or combining software and hardware implementations that may all generally be referred to herein as a “circuit,” “module,” “component,” “manager,” “gateway,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium includes the following: a portable computer diskette, a hard disk, a random access memory (RAM), a read-only memory (ROM), a programmable read-only memory (PROM), an erasable programmable read-only memory (EPROM or Flash memory), an electrically erasable read only memory (EEPROM), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, radio frequency (RF), etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, assembly language, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made through an external computer (for example, through the Internet using an Internet Service Provider) or in a cloud computing environment or offered as a service such as a Software as a Service (SaaS). Generally, any combination of one or more user computers and/or one or more remote computers may be utilized for executing the program code.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that, when executed, can direct a computer, other programmable data processing apparatus, or other devices to function in a particular manner, such that the instructions when stored in the computer readable medium produce an article of manufacture including instructions that, when executed, cause a computer to implement the function/act specified in the flowchart and/or block diagram block or blocks. The computer program instructions may also be loaded onto a computer, other programmable instruction execution apparatus, or other devices to cause a series of operations to be performed on the computer, other programmable apparatuses or other devices to produce a computer implemented process such that the instructions, which execute on the computer or other programmable apparatus, provide processes for implementing the functions/acts specified in the flowchart and/or block diagram block or blocks.

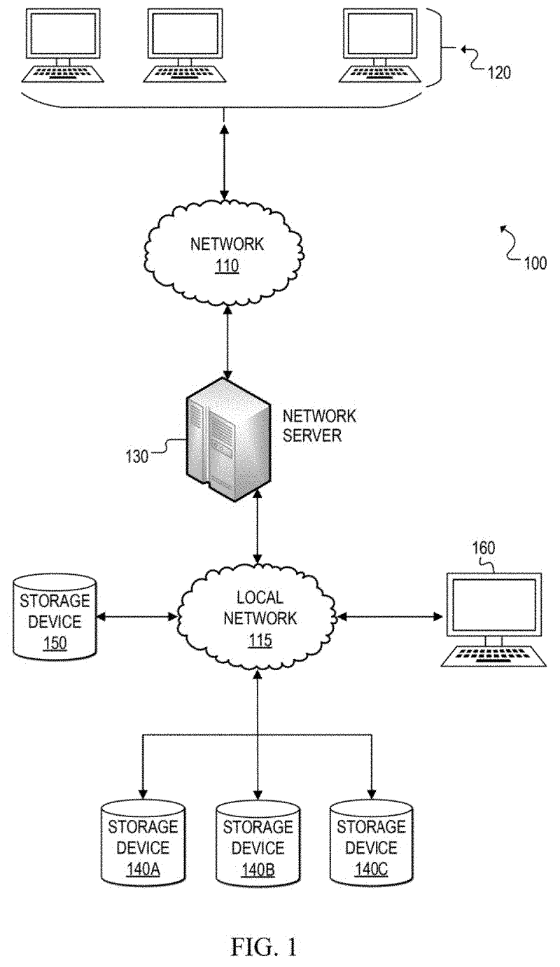

Referring now to FIG. 1, a simplified block diagram is shown illustrating an example communication system 100 for dynamically changing the architecture of a dataset while allowing concurrent user access to data in the dataset according to at least one embodiment. In communication system 100, a network 110 (e.g., a wide area network such as the Internet) facilitates communication between network user terminals 120 and a network server 130. Network server 130 may be configured to communicate with and manage data storage devices 140A, 140B, 140C, and 150, such as direct-access storage devices (DASDs). Network user terminals 120 can enable users to interface with network server 130 and to consume data contained in storage devices (e.g., 140A-140C, 150). A user terminal 160 may be used to enable an authorized user, such as a Database Administrator (DBA), to communicate with and issue commands to network server 130 to access the storage devices. In other embodiments, user terminal 160 could be directly connected to network server 130 or could be remotely connected to network server 130 over the Internet, for example. Also, although storage devices 140A-140C are shown as separate storage devices communicating with network server 130 via local network 115, it should be apparent that one or more of these storage devices may be combined in any suitable arrangement and that any of the storages devices 140A-140B and 150 may be connected to network server 130 directly or via some other network (e.g., wide area network, etc.).

In at least one embodiment, network server 130 is configured to dynamically change the architecture of an existing dataset of a storage device (e.g., 140A-140C) while allowing concurrent user access (e.g., retrieving, reading, modifying, adding, deleting, etc.) of data in that dataset. The architecture of an existing (source) dataset can be changed by allocating a new (target) dataset on a separate storage device (e.g., 150) that offers a desired architecture configuration, and then migrating the data from the source dataset to the newly allocated target dataset.

For purposes of illustrating certain example techniques of communication system 100 for dynamically changing the architecture of a dataset while allowing concurrent user access to data of the dataset, it is important to understand the activities that may be occurring in a network environment that includes data storage devices configured with data structures capable of hosting large quantities of data and providing online user access to the data. The following foundational information may be viewed as a basis from which the present disclosure may be properly explained.

Data structures are used by storage devices (e.g., MSDs, DASDs) to store massive amounts of data across virtually every sector of society including, but not limited to, social media, business, retail, health, education, and government. A database is one type of data structure and generally refers to an organized collection of data. Although the concepts presented herein are applicable to any type of data structures used in storage devices, most of the world's data is stored in a data structure commonly referred to as a database. Therefore, although the discussion herein may reference databases for ease of illustration, it should be understood that the concepts are also applicable to other types of data structures.

Databases can have a logical structure that an end user can view online, such as logical data columns arranged in logical data rows. These logical data columns are stored in a logical data table. A database can contain any number of data tables, and a data table can be stored in a dataset of a storage device. A dataset is the physical storage of a storage device and is typically a long string of data representing data bytes. Data rows and logical data columns are configured in data tables to enable data to be retrieved and presented in a user-friendly format.

Generally, large database environments are created using the dataset architecture that exists at the time of creation. As time passes, new architectures may be developed that offer more efficiency, speed, and storage than the old architectures. In order to change a block size and/or a device type used for a database, a Database Administrator (DBA) (or other authorized individual) performs several actions. First, user processing to the database data tables is stopped. Second, the database is closed to all processing (e.g., user accesses, utility processes, etc.). Third, the database datasets are backed up to an external device (e.g., data is copied to a tape or other storage device). Fourth, old datasets may be deleted. Fifth, the datasets are reallocated with the new architecture (e.g., new block sizes, new device types, etc.). Finally, the reallocated datasets are initialized and loaded with data from the backup. This process can take hours, days, or even weeks depending on the size of the datasets. During that time, users, utility processes, and batch processes are all prevented from accessing the data.

In past decades, entities seeking to convert their old database architectures to new database architectures typically had certain windows of opportunity when their databases would go offline (e.g., for periodic maintenance, etc.) and would be inaccessible to users. As the interconnected world has evolved, however, many applications no longer have a scheduled offline period. Rather, many consumers and other users expect 24/7 access to online data needed to conduct business, purchase goods, manage finances, access services (e.g., transportation, etc.), etc. Although datasets architected for older direct access storage device (DASD) models may need to be updated to current DASD architectures to exploit improved features of the newer architecture, often the user data in the datasets of the old architecture cannot be taken offline.

In one example, consumers may expect 24-hour access to a retailer's online application so that goods (e.g., shoes, clothing, electronics, cosmetics, etc.) can be purchased whenever the consumer desires. In another example, some interconnected systems around the world require availability to certain types of data across time-zones. For example, a country's customs/border control branch may require an online vetting application to be available at all times to allow transportation services (e.g., airlines, railroads, water transport, etc.) to receive clearance for travelers into the country.

In one specific example, an entity may have datasets defined as an older DASD architecture (e.g., IBM 3380) that are in-use and being emulated to run on current DASD technology. Due to the emulation, the datasets provide limited capabilities and reduced performance. For example, an IBM 3380 DASD, which was first available in the 1980s, is a device type characterized by a design specification of 47,476 bytes per track and 15 tracks per cylinder. The average seek time was 16 milliseconds. Newer DASD architecture such as the IBM 3390 is a device type characterized by a design specification of 56,664 bytes per track, 15 tracks per cylinder, and an average seek time of 9.5 milliseconds. Although many IBM 3380 devices have been replaced by modern DASD devices, during the conversion to the new hardware, the dataset definitions were often left unchanged to ensure compatibility with existing database processing. The new DASD devices may be capable of emulating the older mainframe architectures (e.g., IBM 3380), and so the amount and format of data is often defined using the specifications of the older architecture. Thus, capacity and capabilities of the new DASD hardware is limited due to the emulation of the older DASD architecture.

In another specific example, an entity may have datasets defined with older architectures that were defined for use in earlier processing complexes where data transfer rates of the DASD architecture were slower and users needed to limit block sizes to get the best input-output (I/O) throughput. Data, such as logical data rows, is stored in physical data blocks. These physical data blocks can range in size depending on the platform and the DASD hardware. For example, on the mainframe block sizes can be up to 32K bytes and are defined per user application. In older hardware devices the data transfer rate to retrieve a 16K block of data was typically more that the data transfer rate to move a 4K block of data. Consequently, smaller block sizes (e.g., 4K bytes) were often chosen when defining datasets for user applications using older architecture. Also, the actual transferred data block was stored in memory (also referred to herein as “data buffer,” “buffer” or “buffer memory”), and in older mainframe systems, the amount of memory was often limited. Database administrators (DBAs) needed to limit how much memory was used to store the retrieved data blocks. For most database applications, having four small blocks (4K) in buffer memory provided better performance than one large 16K block in a buffer memory.

Over time, significant changes have occurred both to the DASD storage devices as well as available memory in systems. Data transfer rates have grown exponentially, allowing much larger block sizes to perform at the same speed, while providing more data per I/O operation. These changes have greatly reduced the concern over data transfer rates. Moreover, the addition of (64-bit) memory has significantly increased the available memory for storing data in buffer memory. Thus, many database applications currently running on old architecture using a 4K block size, are likely to experience enhanced performance by increasing dataset block sizes to exploit more recent architecture (e.g., IBM 3390 DASD) implementations such as 16K or 28K block sizes.

In yet another example, there can be significant wasted DASD space and buffer memory when a poor block size is selected and implemented. This may occur when a DBA (or other individual who designs the database) does not have an adequate understanding of database buffering concepts. In a database, database blocks are stored in memory in data buffers. Data buffers are allocated in pools. A data buffer pool is chosen depending on the data block size that is retrieved. Accordingly, a buffer pool should be chosen that is as close to the data block size as possible without the data block size exceeding the buffer pool size. In some scenarios, however, a non-database practice of defining dataset block size as a multiple of data row size is sometimes used. By way of example, the following data block size selections are the result of defining the block sizes as 10- or 20-multiples of the data row size, which can yield significant wasted DASD space and buffer memory:

| Data row | Data Block Size | Data Buffer Size |
|---|---|---|
| 312 | 3120 | 4K (4096) |
| 123 | 2460 | 4K (4096) |
| 711 | 7110 | 8K (8192) |
| 411 | 4110 | 8K (8192) |

Thus, several scenarios can result in old dataset architectures being used even though newer technology offers more efficiency, space, and processing speed. Consequently, in some cases, databases rely on decades-old technology, resulting in higher costs, wasted resources, and unnecessary time spent waiting for processing to complete because they cannot afford for the data to be inaccessible to the end users.

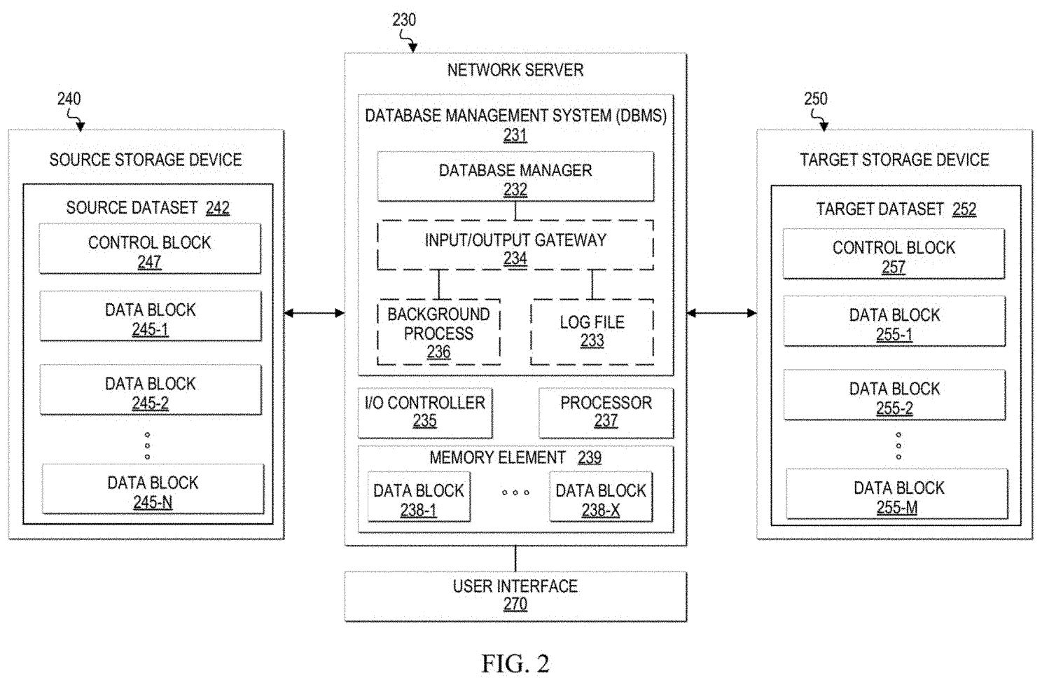

A communication system, such as communication system 100 for dynamically changing the architecture of an existing dataset, as outlined in FIGS. 1 and 2, can resolve these issues and others. This system enables the underlying architecture of datasets to be re-architected to another (e.g., newer, improved) architecture without interruption to users who are accessing the database tables that reside on those datasets. For example, a database administrator (DBA) may determine that one or more database datasets are defined in a non-optimal or even unsupported dataset architecture. The DBA determines that processing for the data tables on this dataset could be improved by re-architecting the dataset to better fit current hardware capabilities. The DBA can define a new (target) dataset on a new storage device with the preferred dataset architecture. In other implementations, a target dataset can be automatically defined based on default or pre-defined architecture specifications. When ready, the DBA (or an automatic process), can trigger a background migration process where each data row is migrated from the old dataset to the new dataset without interrupting the end user access on the data tables.

More specifically, a DBA (or automatic process) can allocate a target dataset and define the preferred architecture, such as block size and device type. For example, an existing dataset defined on an IBM 3380 with a 4K block size may be re-architected to a target dataset defined on an IBM 3390 with a 28K block size. Once the target dataset is allocated, the architecture change process can be triggered when desired. In one embodiment, the architecture change process may first establish that the target dataset is sufficiently sized and suitably architected to hold the data tables being migrated from the source dataset. The architecture change process can establish an input-output (I/O) gateway around the source and target datasets to maintain consistency of reference for all data rows that are migrated from the source dataset to the target dataset. The I/O gateway begins migrating logical data rows from a data block in the source dataset to a data block in the target dataset. The data rows are migrated independently of data blocks, as the new architecture may change the number of data rows per data block. In at least one embodiment, the data rows are migrated in native sequence from the source dataset to the target dataset. Transactional logging may be provided for all data rows to enable a fully restartable and recoverable process in the event of an unintentional processing failure (e.g., power outage, processor failure, system failure, and other abnormal terminations, etc.).

One or more embodiments manage concurrent access to data in the datasets as data rows are migrated from the source dataset to the target dataset. End user processing is performed by logical data row and does not require a data row to be housed in a particular dataset. Thus, the I/O gateway manages access to the data rows by end users, where a particular data row may be accessed from either the source dataset or the target dataset depending upon whether it has been migrated at the time of the user request. The I/O gateway can also manage data row accesses by other database utility processes. This is achieved by ensuring that the data row migration is integrated with these other utility processes. For example, a utility process that attempts to run concurrently with I/O gateway may be blocked until a particular data row migration is complete. However, for at least some utility processes, the utility process is automatically integrated with the I/O gateway, which manages accesses to the source and target datasets by the utility process and allows for successful completion. In some cases, where the requested utility process is blocked because it conflicts with the migration process, an alternative utility process may be provided that performs the utility function integrated with the I/O gateway.

In one or more embodiments, the architecture change process can be completed by renaming the target dataset to the original name of the source dataset. The source dataset may be deleted or renamed. It should also be noted that multiple datasets can be re-architected at the same time. An I/O gateway can be created for each dataset being re-architected.

Embodiments of an architecture change process can offer several advantages. For example, embodiments described herein enable DBAs to quickly migrate data tables from one architecture to another, different architecture with enhanced capabilities and features. Moving to a different architecture can improve performance, remove restrictive requirements for older architectures (e.g., older DASD architectures), and reduce costs of maintaining the environment. The particular embodiments described herein for dynamically changing the architecture of a dataset enable a DBA to implement critical business required architecture changes without interrupting the business. Thus, users may continue to access needed data from a dataset being re-architected without any downtime.

Turning to FIG. 1, a brief description of the infrastructure of communication system 100 is now provided. Elements of FIG. 1 may be coupled to one another through one or more interfaces employing any suitable connections (wired or wireless), which provide viable pathways for network communications. Additionally, any one or more of these elements of FIG. 1 may be combined or removed from the architecture based on particular configuration needs.

Generally, communication system 100 can be implemented in any type or topology of networks. Within the context of the disclosure, networks such as networks 110 and 115 represents a series of points or nodes of interconnected communication paths for receiving and transmitting packets of information that propagate through communication system 100. These networks offer communicative interfaces between sources, destinations, and intermediate nodes, and may include any local area network (LAN), virtual local area network (VLAN), wide area network (WAN) such as the Internet, wireless local area network (WLAN), metropolitan area network (MAN), Intranet, Extranet, virtual private network (VPN), and/or any other appropriate architecture or system that facilitates communications in a network environment or any suitable combination thereof. Additionally, radio signal communications over a cellular network may also be provided in communication system 100. Suitable interfaces and infrastructure may be provided to enable communication with the cellular network.

In general, “servers,” “clients,” “computing devices,” “storage devices,” “network elements,” “database systems,” “network servers,” “user devices,” “user terminals,” “systems,” etc. (e.g., 120, 130, 140A-140C, 150, 160, etc.) in example communication system 100, can include electronic computing devices operable to receive, transmit, process, store, or manage data and information associated with communication system 100. As used in this document, the term “computer,” “processor,” “processor device,” “processing device,” or “I/O controller” is intended to encompass any suitable processing device. For example, elements shown as single devices within communication system 100 may be implemented using a plurality of computing devices and processors, such as server pools including multiple server computers. Further, any, all, or some of the computing devices may be adapted to execute any operating system, including IBM zOS, Linux, UNIX, Microsoft Windows, Apple OS, Apple iOS, Google Android, Windows Server, etc., as well as virtual machines adapted to virtualize execution of a particular operating system, including customized and proprietary operating systems.

Further, servers, clients, computing devices, storage devices, network elements, database systems, network servers, user devices, user terminals, systems, etc. (e.g., 120, 130, 140A-140C, 150, 160, etc.) can each include one or more processors, computer-readable memory, and one or more interfaces, among other features and hardware. Servers can include any suitable software component, manager, controller, or module, or computing device(s) capable of hosting and/or serving software applications and services, including distributed, enterprise, or cloud-based software applications, data, and services. For instance, in some implementations, a network server 130, storage devices 140A-140C and 150, or other subsystem of communication system 100 can be at least partially (or wholly) cloud-implemented, web-based, or distributed to remotely host, serve, or otherwise manage data, software services and applications interfacing, coordinating with, dependent on, or used by other services, devices, and users (e.g., via network user terminal, other user terminals, etc.) in communication system 100. In some instances, a server, system, subsystem, or computing device can be implemented as some combination of devices that can be hosted on a common computing system, server, server pool, or cloud computing environment and share computing resources, including shared memory, processors, and interfaces.

While FIG. 1 is described as containing or being associated with a plurality of elements, not all elements illustrated within communication system 100 of FIG. 1 may be utilized in each alternative implementation of the present disclosure. Additionally, one or more of the elements described in connection with the examples of FIG. 1 may be located external to communication system 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

FIG. 2 is a simplified block diagram that illustrates additional possible details that may be associated with certain components of communication system 100. Specifically, a network server is one possible example of network server 130, a source storage device 240 is one possible example of storage devices 140A, 140B, and/or 140C, and target storage device 250 is one possible example of storage device 150. The elements of FIG. 2 are representative of possible components during an architecture change process in which data rows in a source dataset 242 of source storage device 240 are being migrated to a target dataset 252 of target storage device 250.

Network server 230 may include a database management system (DBMS) 231, which creates and manages databases, including providing batch utilities, tools, and programs. A database manager 232 can create a database processing region (also referred to as a multi-user facility (MUF)) where user processing and most utility processes flow. During an architecture change process, database manager 232 can create an input/output (I/O) gateway 234. In at least one embodiment, I/O gateway 234 may be created temporarily in software and removed from DBMS 231 once the architecture is changed. I/O gateway 234, when executed, can create a background process 236, which migrates data rows from a source dataset (e.g., 242) to a target dataset (e.g., 252), while I/O gateway 234 handles concurrent user processing to access the data rows being migrated. I/O gateway 234 can also create a log file 233 to store information related to each data row migration. Thus, log file 233 can provide information that enables restartability and recoverability if the architecture change process experiences a failure (e.g., power outage, system failure, etc.). Log file 233 may be implemented internal or external to DBMS 231, based on particular implementations and needs. In FIG. 2, log file 233 is shown as internal to DBMS 231 in storage.

Network server 230 may also include hardware including, but not limited to, an I/O controller 235, a processor 237, and a memory element 239. The I/O controller 235 may facilitate communication to both source storage devices (e.g., 240) and target storage devices (e.g., 250), or in other implementations, multiple I/O controllers may be used. In some implementations, a user interface 270 may also be coupled to network server 230. User interface could be any suitable hardware (e.g., display screen, input devices such as a keyboard, mouse, trackball, touch, etc.) and corresponding software to enable an authorized user to communicate directly with network server 230. For example, in some scenarios, a DBA may configure target datasets and initiate the architecture change process using user interface 270.

At any given time, memory element 239 may contain data blocks 238-1 through 238-X, which are loaded into memory based on user access requests received for data rows contained in those blocks. In at least one embodiment, memory element 239 may contain buffer memory and data blocks 238-1 through 238-X may be loaded into buffers in the memory. Multiple users may access, via user terminals, data rows in data blocks that are loaded into memory element 239. Database manager 232 can also be configured to manage concurrency control for users accessing data rows simultaneously, so that adverse effects are prevented if multiple users try to modify resources other users are actively using.

Source storage device 240 and target storage device 250 are representative of different types of physical storage devices capable of storing data in data structures (e.g., databases) that enable multiple users, processes, and utilities to access and, in some cases, modify the stored data. Each storage device 240 and 250 includes a respective dataset 242 and 252, which is the physical storage of data in the storage device. Prior to an architecture change process, source dataset 242 may store data in data blocks 245-1 through 245-N. In at least some embodiments, during the architecture change process, a control block 247 may be added to unused space in source dataset 242 to hold information related to the data migration. Target dataset 252 may be allocated with defined blocks, such as data blocks 255-1 through 255-M, prior to an architecture change process being initiated for source dataset 242. During the architecture change process, a control block 257 may be added to unused space in target dataset 252 to hold information related to the data migration. The background migration process can cause data blocks 255-1 through 255-M to be filled with data rows from source dataset 242.

In at least one scenario, source dataset 242 may be defined with a different architecture than target dataset 252. For example, source dataset 242 may be defined on a less preferred architecture, such as an older data storage device using a small block size (e.g., IBM 3380 with a 4K block size). Target dataset 252 may be defined on a different architecture (e.g., a preferred architecture). In one example, target dataset 252 may be defined on newer technology that enables a larger block size to be utilized (e.g., IBM 3390 with 18K or 28K block size). Consequently, when the migration of source dataset 242 to target dataset 252 is complete, the number of data blocks (M) in target dataset 252 may be different than the number of data blocks (N) in source dataset 242 if their block sizes are different. For example, if source dataset 242 is defined on an IBM 3380 with a 4K block size and target dataset 252 is defined on an IBM 3390 with a 28K block size, then target dataset 252 will likely have fewer blocks than source dataset 242 (i.e., M<N).

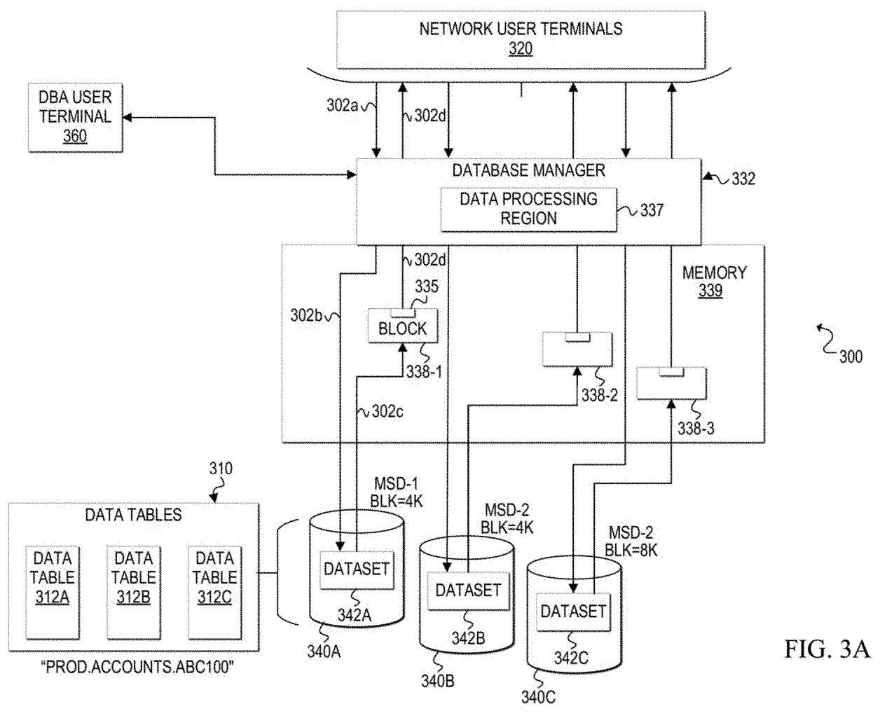

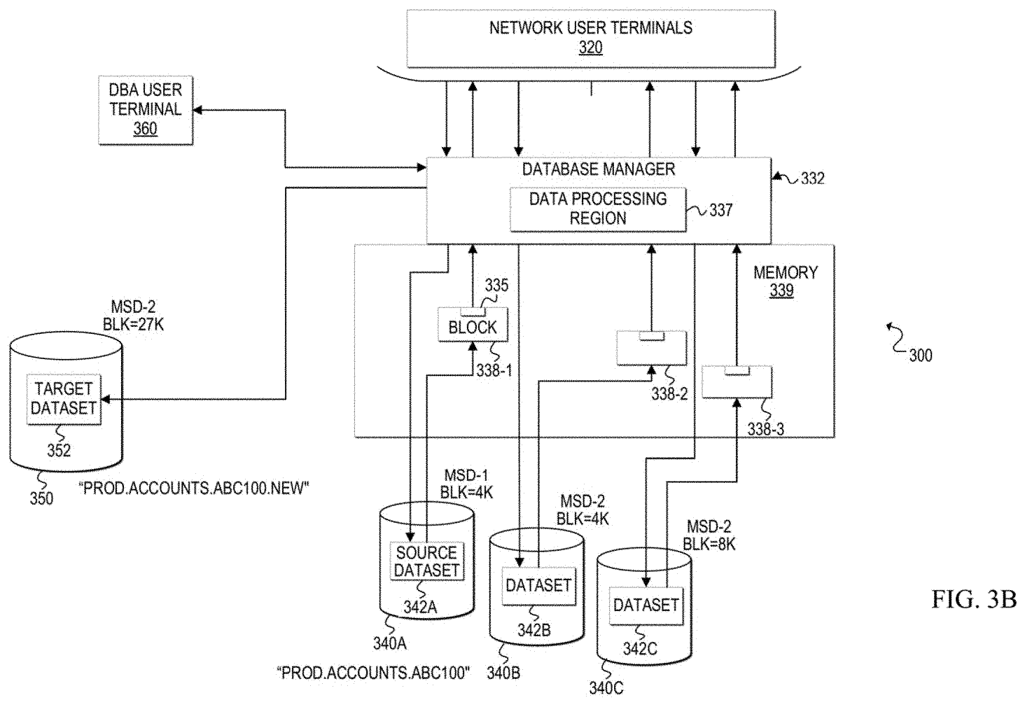

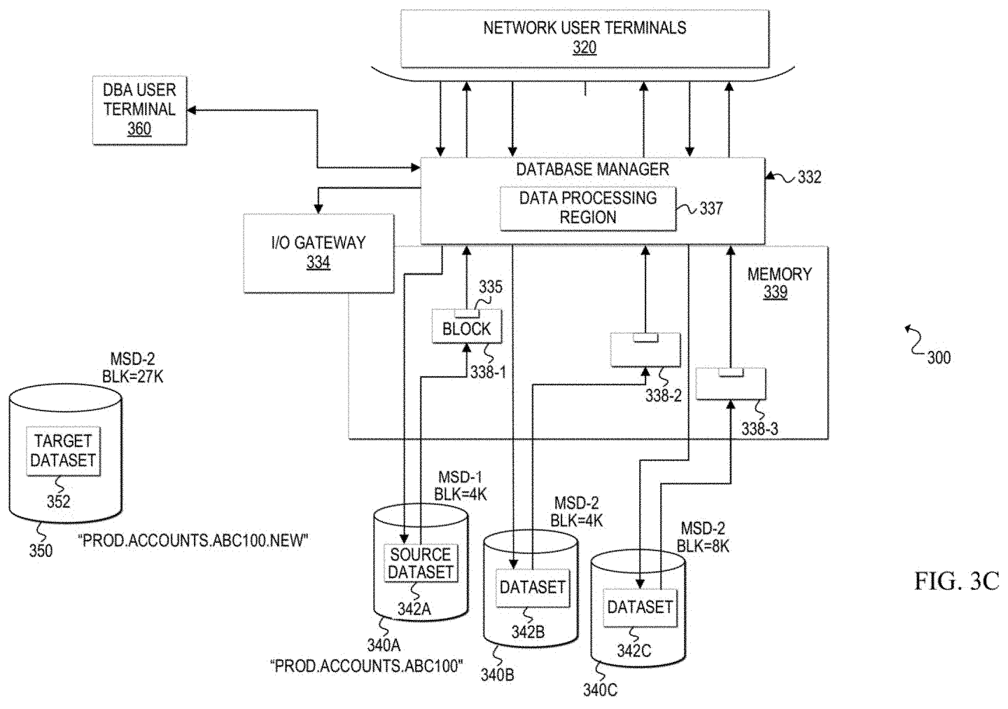

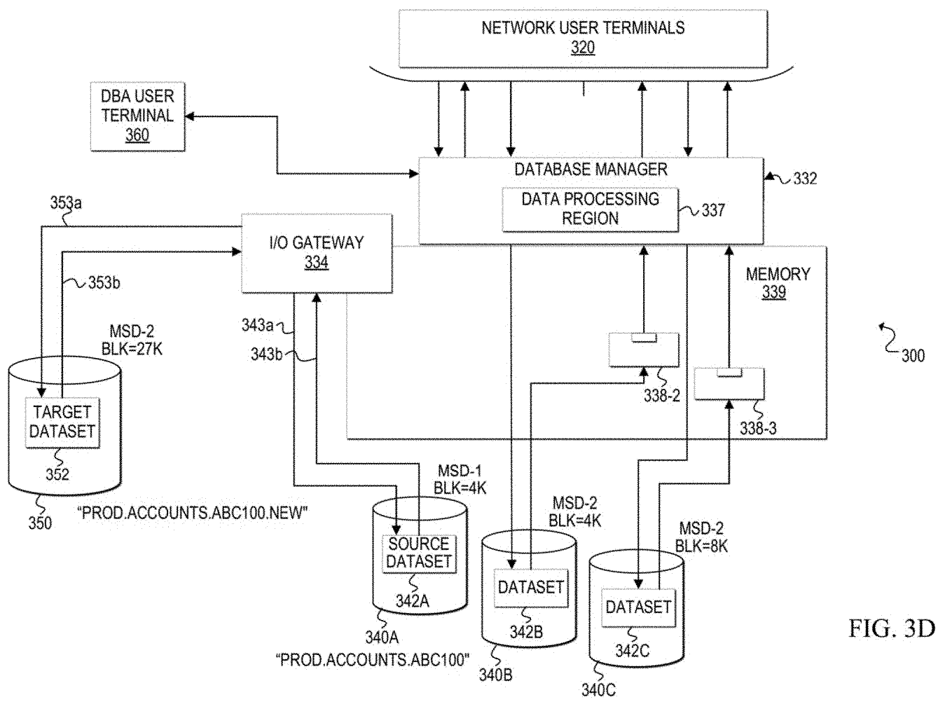

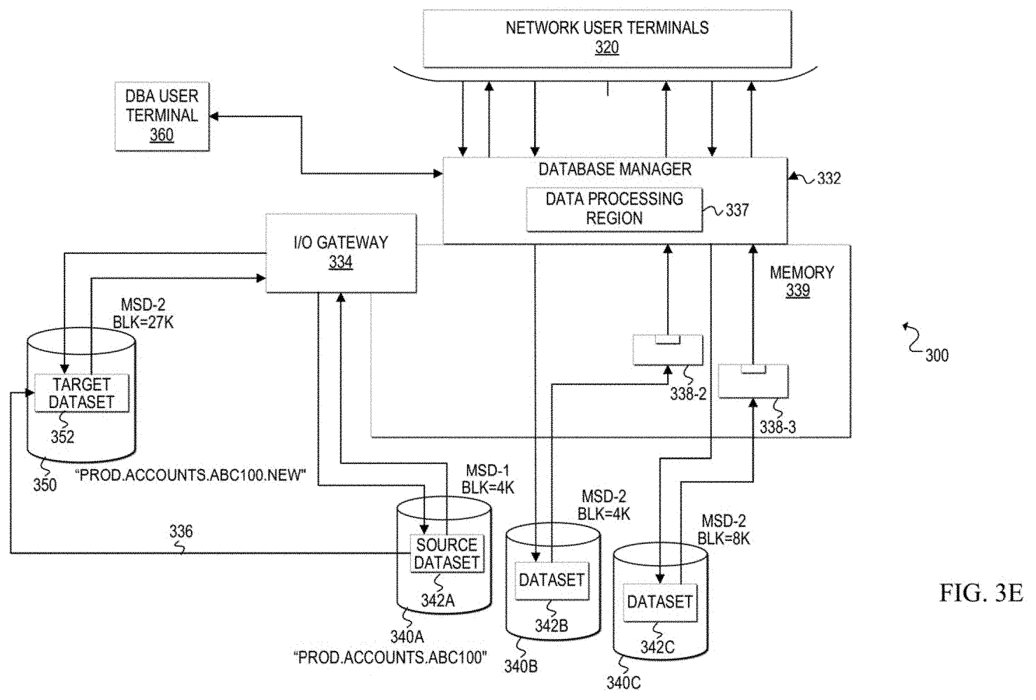

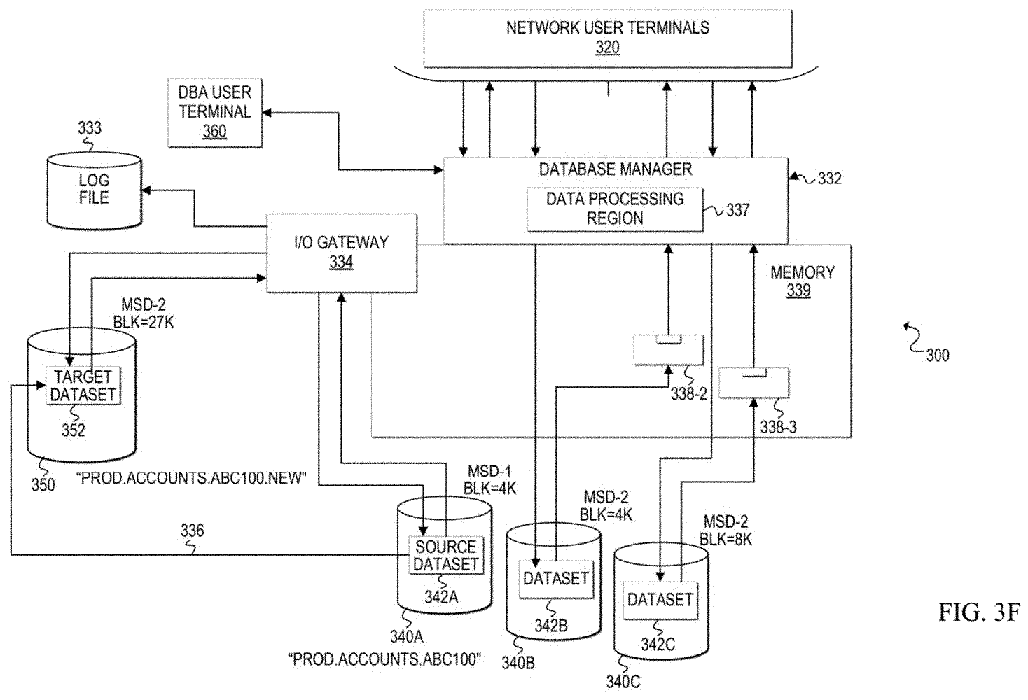

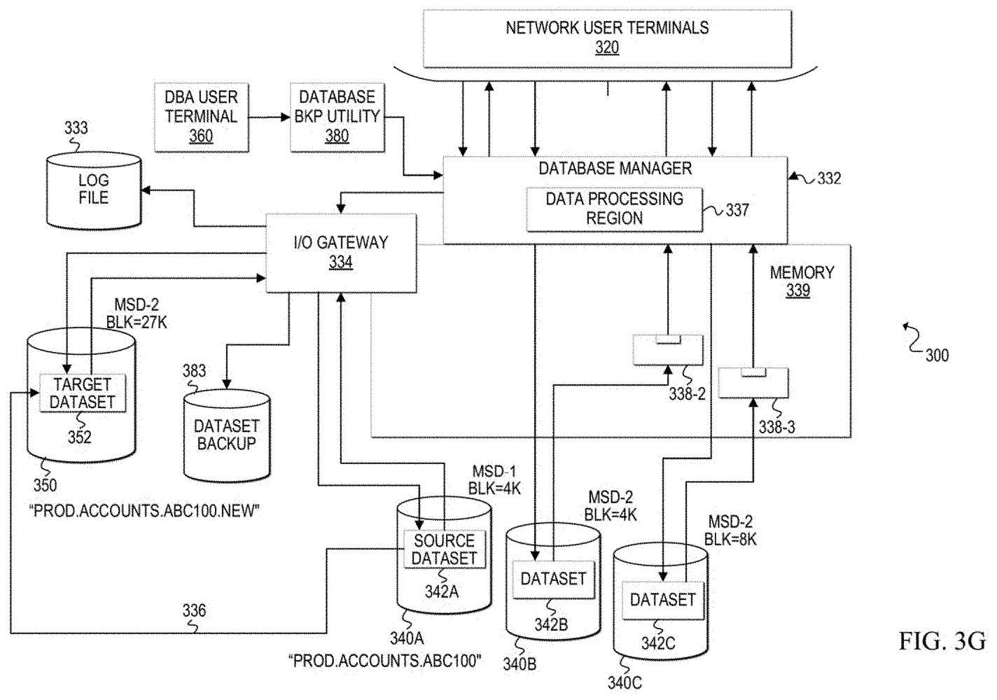

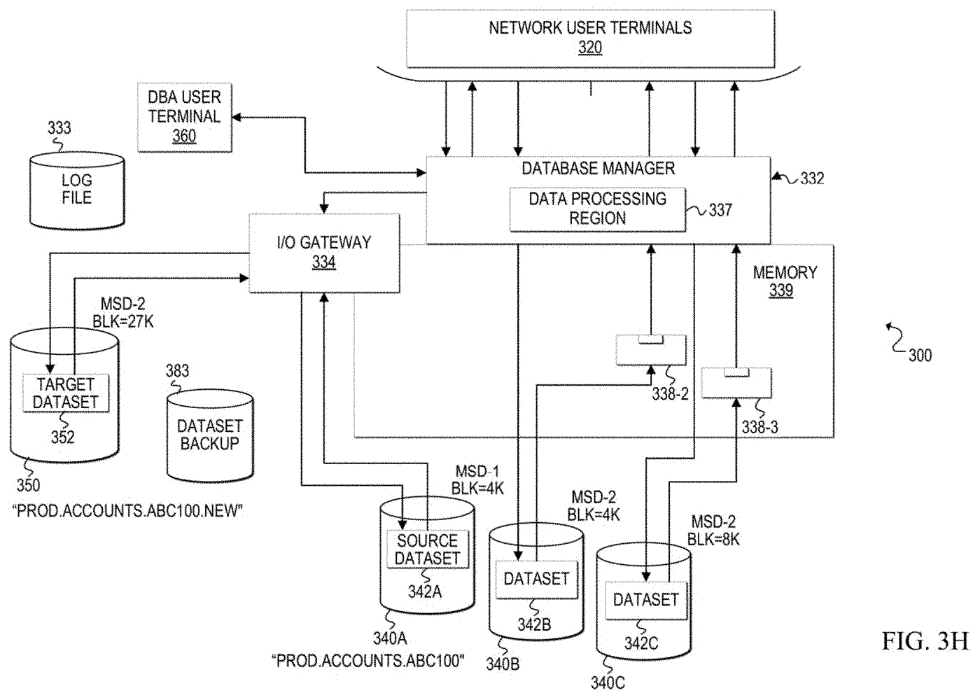

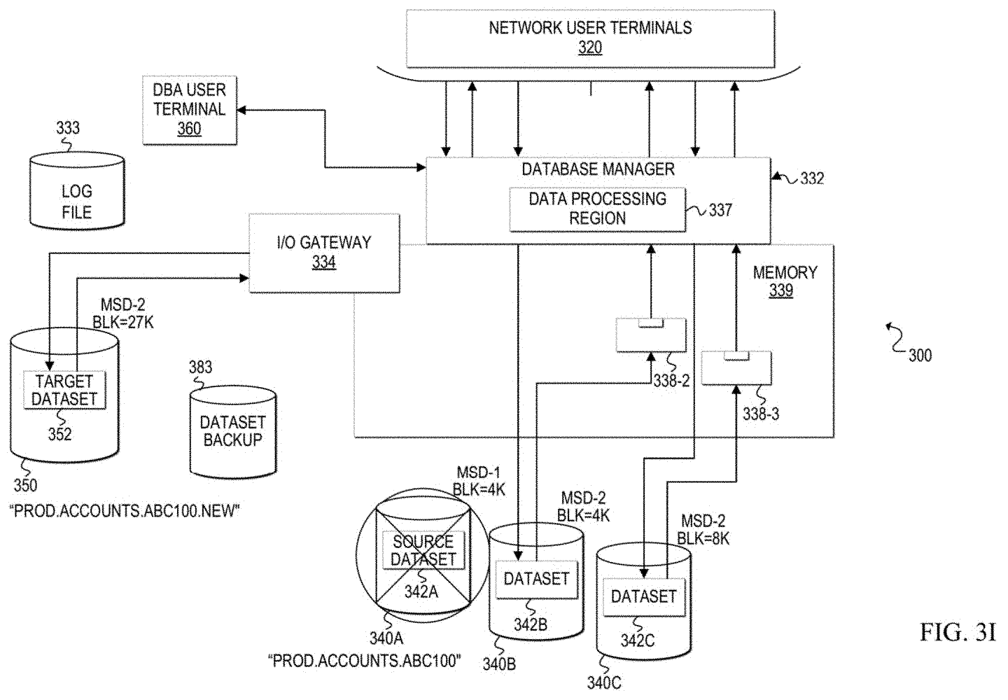

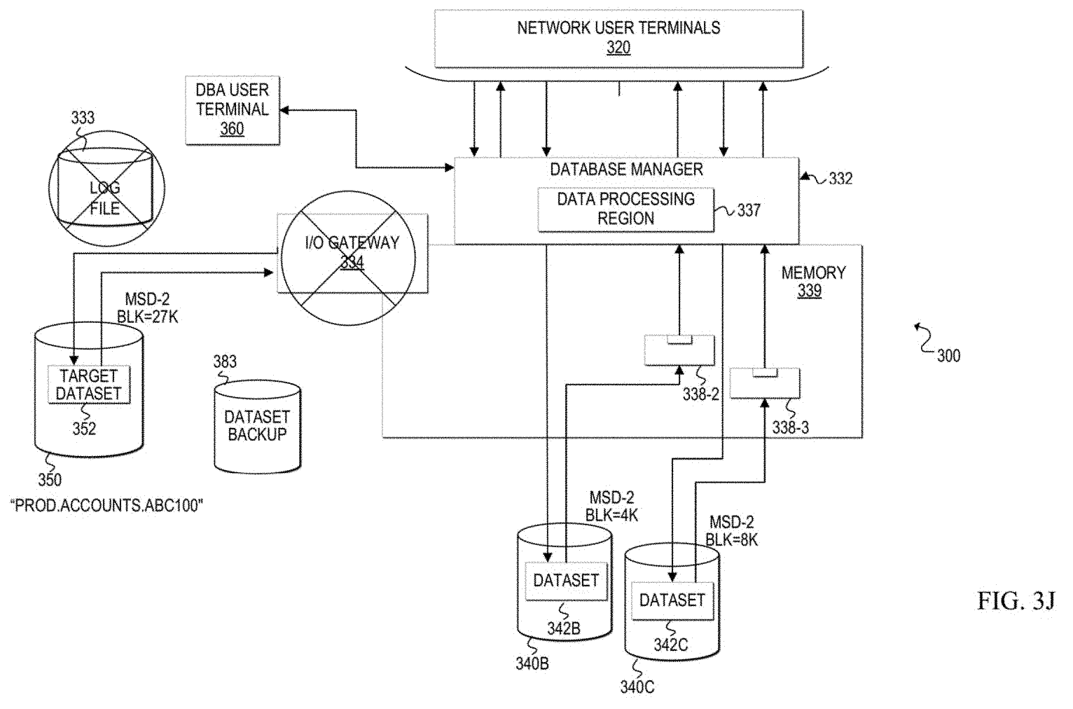

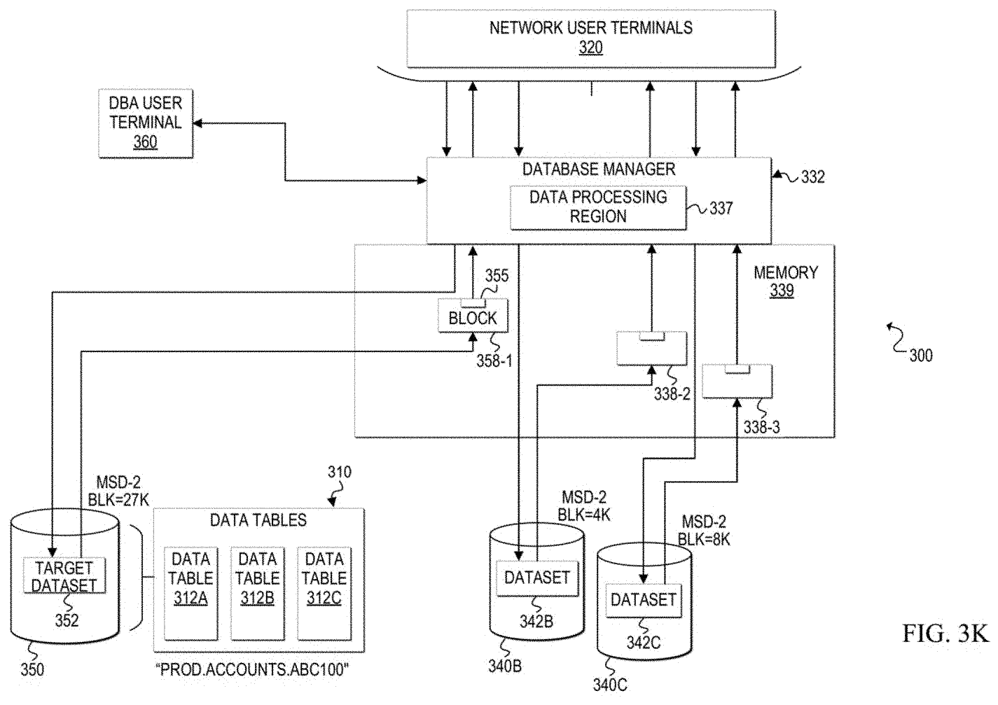

Turning to FIGS. 3A-3K, block diagrams illustrate an example scenario of a database environment and an architecture change process applied to a dataset within the environment. A communication system 300 includes network user terminals 320, a DBA user terminal 360, a database manager 332 with a data processing region 337, a memory 339, and storage devices 340A-340C of a database environment managed by database manager 332. The database environment can include multiple database datasets (e.g., 342A, 342B, 342C). The datasets contain logical data tables and the datasets may be stored in multiple architectures (e.g., different device types, different block sizes). User data rows are stored as logical data table(s) in the datasets.

With reference to FIG. 3A, an example database environment scenario is shown. Data storage devices 340A-340C contain respective datasets 342A-342C. Data tables 310 are stored in dataset 342A, and the other data tables (not shown) are stored in the other datasets 342B and 342C of the database. Each data table 312A-312C stored in dataset 342A may contain different information (e.g., customer information, order information, inventory information, etc.). For example, data table 312A may be a customer data table, data table 312B may be an order data table, and data table 312C may be an inventory data table. Each dataset has a unique file name and, in this example scenario, dataset 342A has a file name of “PROD.ACCOU NTS.ABC100.”

Also in this example scenario, datasets 342A-342C are shown with different architectures. Dataset 342A is defined on a first mass storage device type (MSD-1) with a block size of 4K bytes. Dataset 342B is defined on a second mass storage device type (MSD-2) with a block size of 4K bytes. Dataset 342C is defined on another MSD-1 with a block size of 8K bytes.

Data processing region 337 receives flows of user requests from users via network user terminals 320 and from database administrator(s) via DBA user terminal 360. Data processing region 337 can also receive database access requests from utility and other non-end user processes. In operation, multiple users (e.g., tens, hundreds, thousands, etc.) can access the database concurrently via network user terminals 320. FIG. 3A shows concurrent user requests (e.g., for data access or modification) for data contained in each of the datasets 342A-342C. An example user request will now be described with reference to dataset 342A. For illustrative purposes, the description is based on a user request for a data row in the customer data table 312A, which is stored in dataset 342A.

At 302a, a user requests, via a network user terminal 320, access to a customer data row in customer data table 312A. Data processing region 337 receives the user request. At 302b, data processing region 337 determines the location of a data block that contains the requested data row. In this example, data processing region 337 determines the location of the data block, which is in dataset 342A of storage device 340A.

At 302c, data processing region 337 retrieves into memory 339 the identified data block from the appropriate dataset holding the customer data table. The data block is retrieved into memory as block 338-1, with requested data row 335. In one example, block 338-1 may be stored in buffer memory of memory 339. At 302d, the requested data row 335 is extracted and returned to the network user terminal that submitted the user request at 302a.

User accesses to other data tables (e.g., 312B, 312C) may occur at least partially concurrently to the user access of customer data table 312A. In addition, other user accesses to customer data table 312A may also occur at least partially concurrently with the user access shown and described in FIG. 3A. These other user requests may be directed to data rows in other data blocks or in the same data block 338-1. Database manager 332 manages the concurrency of concurrent user requests for access and/or modifications to data contained in the same data table. In addition, as shown in FIG. 3A, user accesses to other data tables in different datasets (e.g., 342B, 342C) may also occur at least partially concurrently (or not concurrently) to the user accesses of data tables 310. It should be apparent that in at least some systems, continuous concurrent access by two or more users is possible.

FIGS. 3B-3K illustrate various stages during an architecture change process, which will now be explained. While normal database processing is occurring (e.g. multiple concurrent user requests), a determination can be made that the architecture of a dataset is to be changed (e.g., reconstructed, re-architected, redesigned, etc.). In this example scenario, dataset 342A is the source dataset that is to be re-architected to a target dataset. Currently, source dataset 342A is defined on a first mass storage device type (e.g., MSD-1) with a 4K byte block size.

In FIG. 3B, the DBA can access database manager 332 via DBA user terminal 360 to create a new target dataset with the desired architecture. In this example, the DBA allocates a target dataset 352 on a target storage device 350 and defines its architecture as a second mass storage device type (MSD-2) with a 27K byte block size. In addition, target dataset 352 is given a unique file name. In this example, the unique file name is the source dataset file name with an extra qualifier: “PROD.ACCOUNTS.ABC100.NEW.” In other embodiments, the target dataset may be allocated and defined dynamically based on default, pre-configured, or algorithmically configured architecture parameters. It should be apparent that while specific block sizes such as 18K, 28K and 27K are mentioned herein, the block size of the target dataset is selected to provide an optimal result for the desired architecture. Thus, any suitable block size may be selected for a target dataset based on particular implementations and/or needs.

A database pre-processing utility application may also be executed to prepare the target dataset for data migration from the source dataset. For example, pre-processing may include verifying the presence of source storage device 340A, target storage device 350, source dataset 342A, target dataset 352, the readiness of target dataset 352 for the data migration, etc. A utility application or the DBA may also ensure that enough buffer memory is available in memory 339 for the new target dataset 352.

In FIG. 3C, the DBA may issue a command, via the DBA user terminal 360, to cause database manager 332 to begin architecture change processing. Architecture change processing includes migrating data in the source dataset to the target dataset by data rows. Upon receiving the command, database manager 332 may begin periodically outputting status messages to a display (e.g., DBA user terminal 360, display connected to a network server hosting database manager 332, another remote or local display device, etc.) and/or to a log file of status messages indicating the status of the architecture change process. Initially, database manager 332 may output a start message to indicate the processing has started.

In response to the command to start processing, database manager 332 creates can create an input/output (I/O) gateway 334 in memory to isolate processing for source dataset 342A while it is being re-architected. The I/O gateway 334 may be a dynamically generated, temporary process that runs in a separate processing region to handle the data migration of the source dataset to the target dataset and the concurrent user requests (and utility process requests) for access to data in source dataset 342A during the data migration. Database manager 332 forwards user requests and utility process requests for access to source dataset 342A to I/O gateway 334. The location of a requested data row in dataset 342A at any given time during the architecture change process depends on whether the data row has been migrated. I/O gateway 334 keeps track of where each data row is located during the migration and handles user requests (and utility process requests) accordingly.

Once the I/O gateway is created, as shown in FIG. 3D, the gateway can issue a command to open both the source dataset 342A and the target dataset 352 and can establish connections (e.g., 353a, 353b, 343a, 343b) to both datasets. I/O gateway 334 can access both source dataset 342A and target dataset 352 and knows which data rows are on which dataset at any given time during the data migration performed during the architecture change process. Thus, I/O gateway 334 maintains exclusive control over the datasets during the data migration. Database manager 332 may also output a status message indicating the I/O gateway is built and the datasets are open.

Once the datasets are open and connections are established, as shown in FIG. 3E, I/O gateway 334 creates a background process 336 to migrate data rows from source dataset 342A to target dataset 352. The background process can be invisible to users who may continue to access data in the datasets. Data rows can be migrated by either copying each data row from source dataset 342A to target dataset 352, or by moving each data row from source dataset 342A to target dataset 352. If data rows are copied, a copy of the data rows remains in the source dataset upon completion of the migration. If data rows are moved, then they are deleted from the source dataset. During the migration, database manager 332 may output a status message periodically indicating the number of data rows that have been successfully migrated.

In at least one embodiment, background process 336 migrates data rows sequentially, rather than as a block. In one example, background process 336 migrates the data rows in native sequence. Native sequence is intended to mean a preferred order for the data rows. Often, the preferred order is selected (e.g., by a DBA or designer of the database) based on the most likely processing sequence of the data rows. For example, if requests are typically made in a particular order, then the performance of the database may be increased if data is stored in the dataset in the same order as the most common user requests and/or batch utility requests. It should be noted that, when migrating in native sequence, data rows may be selected across multiple blocks of storage in source dataset 342A. For example, the first 4K block may contain the first data row to migrate, the second 4K block may contain the second data row to migrate, the fifth 4K block may contain the third data row to migrate, and so on. In other embodiments, background process 336 may simply migrate the data rows based on their current order in source dataset 342A or in any other desired order based on particular implementations and needs.

As shown in FIG. 3F, I/O gateway 334 may also create a log file 333 during the migration. I/O gateway 334 can store information in the log file that is related to each successful data row migration. Log file 333 may be used to restart the architecture change process and the migration at the point of the last logged data row migration after a failure (e.g., power outage, system failure, etc.) that causes the architecture change process to cease running.

In many scenarios, it is desirable to perform the migration as quickly as possible. Therefore, in at least one embodiment, as background process 336 performs the data migration, any available processing power may be used to migrate the data. However, some processing power is also allocated to end user requests for data in source dataset 342A. The user requests are directed through I/O gateway 334 so that the users can access any desired data row from source dataset 342A during the architecture change process of source dataset 342A.

FIG. 3G illustrates a scenario that may occur during the architecture change process. In some cases, certain utility applications and other non-end user processes may be initiated during the migration. For example, a DBA may decide that a database backup utility process cannot wait until the architecture change process is finished. For example, a DBA may send a request, via DBA user terminal 360, to database manager 332 to run database backup utility application 380. Because a physical backup process of a dataset cannot be run during its data migration, the database backup utility application 380 is prevented from executing.

In at least one embodiment, upon receiving a request to run database backup utility application 380, database manager 332 may send a response to DBA user terminal 360 denying the request and offering to run an alternative backup utility application within I/O gateway 334 during the data migration. If the DBA agrees to the alternative backup application, database manager 332 can instruct I/O gateway 334 to run the alternative database backup utility application. The alternative database backup utility application is integrated with the I/O gateway 334 such that data rows are provided to the integrated application from the I/O gateway, which has access to both datasets 342A and 352. Thus, the I/O gateway controls and coordinates the backup process with the data migration so that an accurate backup can be performed. The integrated application can store the data rows received from the I/O gateway in another data storage device, such as dataset backup 383. Database manager 332 may provide status messages related to the alternative backup utility process.

FIG. 3H illustrates the database environment once the data migration is complete. When every data row of source dataset 342A has been migrated to target dataset 352, then background process 336 ends. I/O gateway 334 may stop storing information in log file 333. Once the background process ends, however, I/O gateway 334 remains connected to source dataset 342A and target dataset 352 and continues to manage user requests for the data tables that are now stored entirely on target dataset 352. Database manager 332 may output a status message stating the number of data rows that have been successfully migrated and indicating that the data migration is complete.

After the migration is complete, I/O gateway 334 can be disconnected from source dataset 342A, as shown in FIG. 3I. In at least one embodiment, background process 336 may cause the I/O gateway 334 to disconnect from source dataset 342A after the migration is complete, but before the background process ends. The original name associated with source dataset 342A is released (either by deleting or renaming the source dataset) so that the target dataset can be renamed to the original name (i.e., PROD.ACCOUNTS.ABC100). In at least one embodiment, data processing region 337 can delete or rename source dataset 342A. Database manager 332 can output a status message indicating that the old dataset (i.e., source dataset 342A) has been deleted or renamed.

FIG. 3J shows the additional cleanup that is performed once the data migration is finished. First, the background process may rename target dataset 352 to the original name of source dataset 342A, which is now deleted or renamed. In this example scenario, target dataset 352 is renamed to PROD.ACCOUNTS.ABC100. Next, I/O gateway 334 can be stopped or removed and normal processing through data processing region 337 can resume. In at least one embodiment, database manager 332 may remove I/O gateway 334. In one example, log file 333 can be deleted, either by I/O gateway before it is removed, or by database manager 332. Database manager 332 can output a status indicating that the target dataset name has been changed to the original source dataset name, and the process is complete.

FIG. 3K illustrates the database environment after the architecture change process is complete. Target dataset 352 contains data tables 310 and has the original file name of the source dataset that was migrated to the target dataset. Target dataset 352 is accessed by data processing region 337 when a user request (or utility application request) is received for a data row contained in target dataset 352. Data processing region 337 locates the requested data row 355 and retrieves a block 358-1 that contains requested data row 355. The block is loaded into a buffer in memory 339 and data row 355 can be provided to the appropriate user terminal.

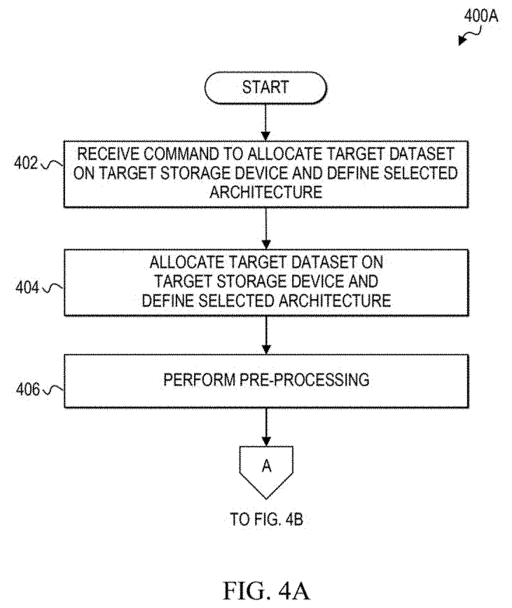

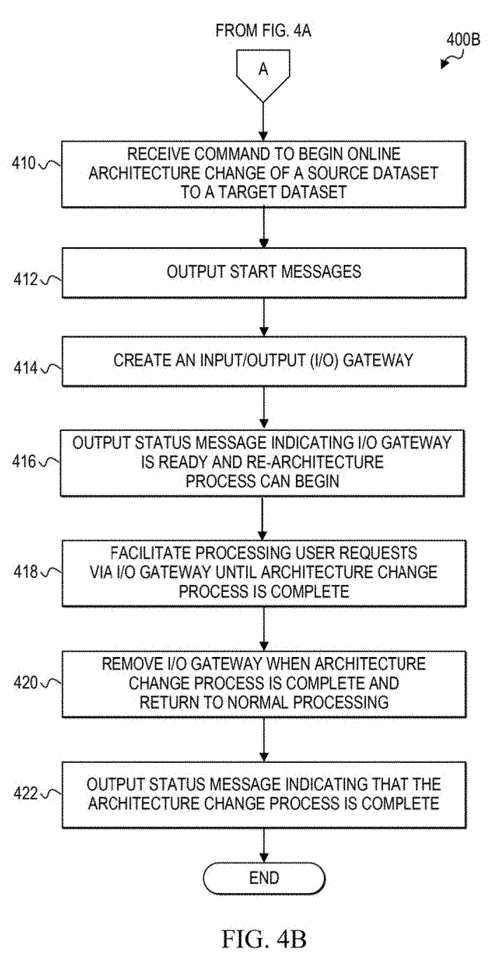

Turning to FIGS. 4A-11, various flowcharts illustrate example techniques related to one or more embodiments of a communication system, such as communication system 100, for dynamically changing the architecture of a source dataset (e.g., 242) of a source storage device (e.g., 240) while allowing concurrent user access to the dataset. The preferred architecture (e.g., storage device type, block size, etc.) is defined for a target dataset (e.g., 252) in a target storage device (e.g., 250), and the data of a source dataset (e.g., 242) is migrated to the target dataset, without interrupting the user access (or utility application access) to data rows of data tables stored in the source dataset. In at least one embodiment, one or more sets of operations correspond to activities of FIGS. 4A-11. A network server, such as network server 230, or a portion thereof, may utilize the one or more sets of operations. In an embodiment, at least some operations of the flows of FIGS. 4A-11 may be performed by database manager 232 and at least some operations may be performed by I/O gateway 234 and background process 236. Network server 230 may comprise means such as processor 237, I/O controller 235, and memory element 239 for performing the operations.

FIGS. 4A-4B are simplified flowcharts 400A and 400B, respectively, illustrating some operations that may be performed by database manager 232 to prepare physical storage devices and processes to re-architect a source dataset, such as source dataset 242. At 402, database manager 232 receives a command to allocate a target dataset on a target storage device and to define the selected architecture for the target dataset. For example, the selected architecture could be a newer storage device type (e.g., IBM 3390) with a larger block size (e.g., 18K, 27K, etc.) than the block size currently defined for the source dataset.

At 404, a target dataset is allocated on the target storage device, such as target dataset 252 on target storage device 250, and the selected architecture is defined for the target dataset.

At 406, pre-processing tasks may be performed before the architecture change process begins. For example, pre-processing tasks may include verifying the presence of the target storage device and target dataset, initializing the target dataset to the appropriate database internal format, verifying the presence of the source storage device and source dataset, and the overall readiness of the source and target datasets for the migration.

In FIG. 4B, at least some of the operations shown may be performed by database manager 232. At 410, a command may be received (e.g., from a DBA via a DBA user terminal) to begin the architecture change process to re-architect source dataset 242 to the preferred target dataset 252.

At 412, the database manager can output start messages to indicate the architecture change process has been initiated. Messages may be sent to a display and/or a log file of messages during the architecture change process. The display may be, for example, a display device of a DBA user terminal or any other display device configured to receive messages from database manager 232.

At 414, database manager 232 can build or create an input/output (I/O) gateway, such as I/O gateway 234 to run in a separate processing region. I/O gateway can open source dataset 242 and target dataset 252 and establish connections to the datasets.

I/O gateway 234 is created to re-architect the source dataset, but not other datasets. Thus, I/O gateway 234 handles only user requests and possibly utility application requests for data rows stored in the gateway's associated source dataset. In at least one embodiment, I/O gateway is temporary and is removed when the architecture change process completes. In other embodiments, I/O gateway 234 may be stopped, stored, and retrieved for later use as an I/O gateway for another source dataset.

When I/O gateway 234 establishes connections to source dataset 242 and target dataset 252, database manager 232 can output a status message at 416 indicating that the I/O gateway is ready, and the architecture change process can begin.

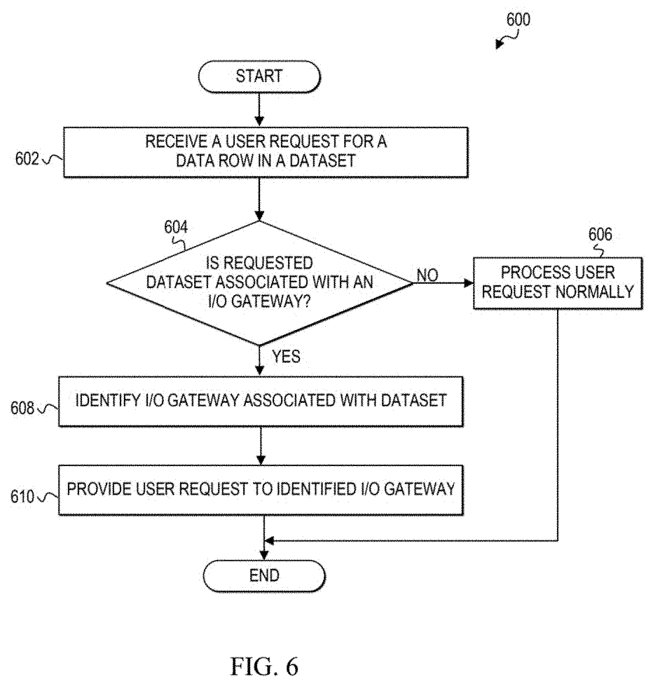

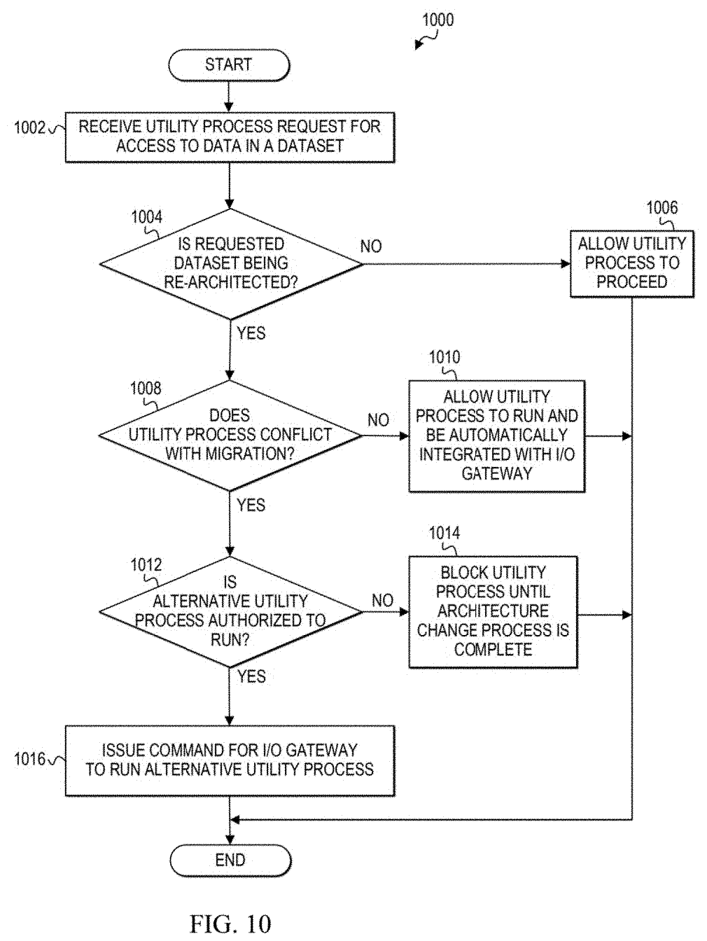

At 418, database manager 232 can provide user requests for data in source dataset 242 to I/O gateway 234 and can receive and appropriately forward responses to those requests from the I/O gateway 234, until the architecture change process is complete. An example of this processing is discussed in further detail with reference to FIG. 6. Database manager 232 can also handle any database utility process requests, including batch process requests and other non-end user process requests. These scenarios are discussed in further detail with reference to FIG. 10.

At 420, once the architecture change process is complete, the database manager 232 can remove the I/O gateway, establish a connection to the target dataset including opening the target dataset, and return to normal processing. Normal processing includes receiving and responding to user requests for data rows in the target dataset by accessing the target dataset, locating the appropriate data rows, and loading the appropriate blocks on the target dataset into memory. Normal processing also includes allowing utility processes that request access to the target dataset to run. At 422, database manager 232 can output a status message indicating that the architecture change process is complete.

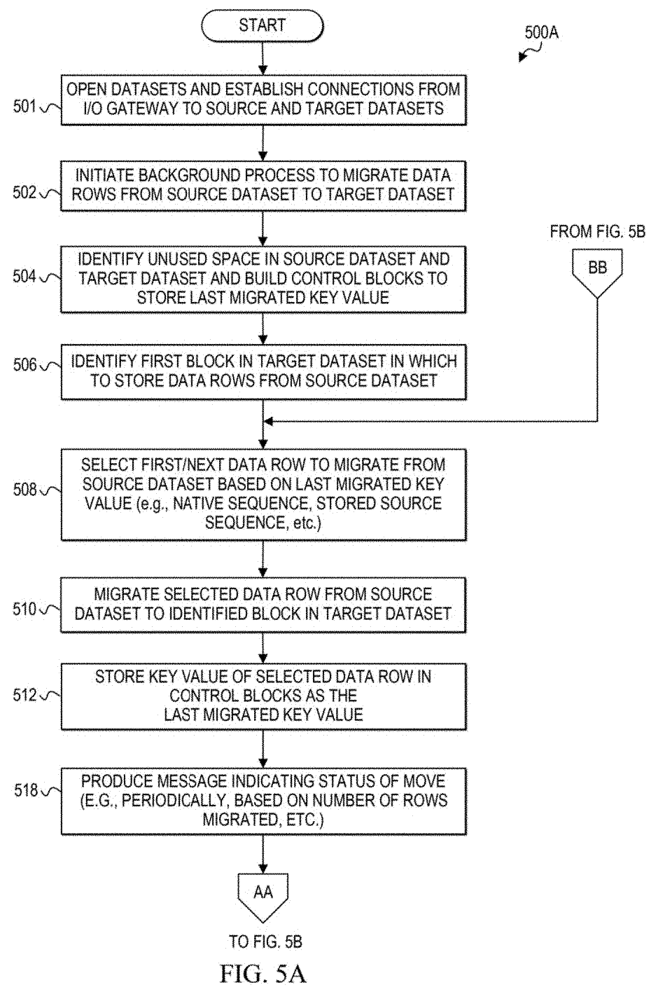

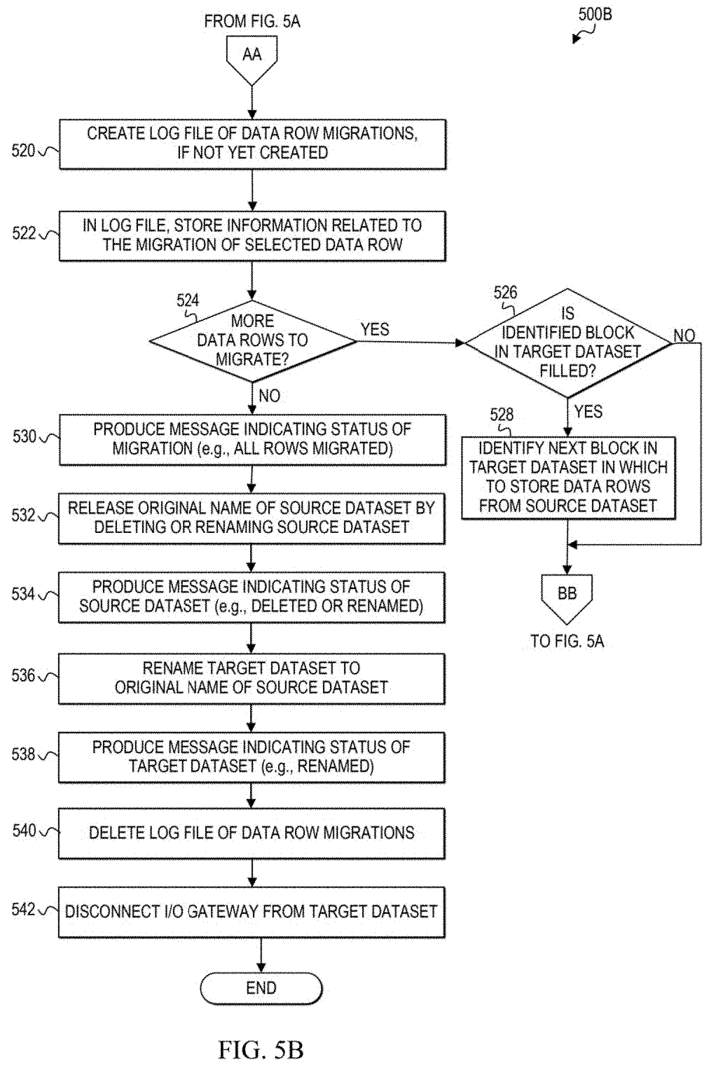

FIGS. 5A-5B are simplified flowcharts 500A and 500B, respectively, illustrating at least some of the activities that may be performed by I/O gateway 234 during the re-architecture of source dataset 242. In at least one embodiment, flowchart 500A begins after database manager 232 has created the I/O gateway to re-architect source dataset 242.

At 501, I/O gateway 234 opens source dataset 242 and target dataset 252. I/O gateway 234 also establishes connections to the source and target datasets.

At 502, I/O gateway 234 can initiate a background process to migrate data rows from source dataset 242 to target dataset 252.

At 504, unused space is identified in both the source dataset 242 and the target dataset 252. A control block can be built on both the identified unused space in the source dataset and the identified unused space in the target dataset. The control blocks can be used to store a last migrated key during the migration of data rows from the source dataset to the target dataset. In one embodiment, each row has a unique key value, and the migration of the data rows is performed sequentially based on the unique key values. In one example, the key values can correspond to the physical order in which the data rows are stored in the source dataset.

In another embodiment, the key values can correspond to the native sequence of the data rows. Over time, data rows in a dataset may become out-of-native-sequence due to modifications to the data rows (e.g., insertions, deletions). In order to migrate the data rows of source dataset 242 in native sequence, the rows may be selected for migration based on each row's native key value. Thus, the migration can effectively reorder the data rows into a native key sequence in target dataset 252.

At 506, the first block in which data rows are to be stored in target dataset 252 is identified. At 508, the first data row to migrate from the source dataset is selected. The data row may be selected based on the last migrated key. Because no data rows have been migrated yet, the value of the last migrated key may be null or zero in some examples. Therefore, in this example, the first data row could be selected based on its associated key value being the lowest key value in a sequence of all the key values associated with data rows in source dataset 242. As previously noted, the key values may be based on any desired order of the data rows depending on particular needs and implementations. For example, the key values may be based on a native sequence of the data rows or a stored sequence of the data rows.

At 510, the selected data row is migrated from source dataset 242 to the identified block in target dataset 252. At 512, the key value associated with the migrated data row is stored in the control blocks in both the source dataset and the target dataset as the last migrated key value. The last migrated key value stored in the control blocks provides a reference to enable identification of which data rows have been migrated at any given time during the migration. For example, the last migrated key value stored in the control blocks can indicate that the data row associated with the last migrated key value, and any other data rows associated with key values that are less than the last migrated key value, have been successfully migrated.

At 518, a message indicating the status of migration may be produced. Status messages may include the number of rows successfully migrated in one example. These messages may not be produced after every data row migration, but rather, may be produced periodically (e.g., 10,000 data rows migrated, 20,000 data rows migrated, etc.). In one embodiment, this message or information can be provided to database manager 232, which can then output the message to an appropriate display or log file of status messages.

At 520, in FIG. 5B, I/O gateway 234 can create a log file of data row migrations, if not already created. At 522, information can be stored in the log file that is related to the migration of the selected data row. Relevant information is saved for each successful data row migration to enable restartability and recoverability if the network server (or components within the network server) should experience some failure that crashes or otherwise interrupts the architecture change process. Information may include, but is not necessarily limited to, the key value of the selected data row, the location of the selected data row in the target dataset, and/or the location of the selected data row in the source dataset.

At 524, a determination is made as to whether there are more data rows in source dataset 242 to be migrated. If there are more data rows to be migrated, then at 526, a determination is made as to whether the identified block in target dataset 252 is filled. If the identified target data block is filled, then at 528, a next block in the target dataset is identified to store with data rows from the source dataset.

If the next block in the target dataset is identified at 528, or if the currently-identified block in the target dataset is determined not to be filled at 526, then the flow loops back to 508, where the next data row is selected to migrate from source dataset 242 to target dataset 252. The last migrated key value is retrieved from the control block of the source dataset or the target dataset. In this case, the last migrated key value from the control block is the key value associated with the first selected data row. The next data row to select is identified by determining the next sequential key value, after the last migrated key value, of a data row in the source dataset.

Flow then continues this loop as previously described until eventually, at 524, it is determined that the source dataset contains no more rows to be migrated. I/O gateway 234 may disconnect from source dataset 242 but retain its connection with target dataset 252. At 530, a message is produced indicating the status of the migrated data rows. In at least one embodiment, information indicating the total amount of data rows that have been migrated may be provided to database manager 232. Database manager 232 may then output the status message to the appropriate display and/or log file of status messages.

Operations at 532-542 are related to enabling database manager to resume normal operations with target dataset 252 replacing source dataset 242 in the database environment. In some cases, one or more operations at 532-542 may be performed by I/O gateway 234, database manager 232, background process 236, and/or other background processes initiated for these activities.

At 532, the original file name of source dataset 242 is released by either deleting or renaming the source dataset. At 534, a message may be produced indicating the status of the source dataset (e.g., deleted or renamed). In at least one embodiment, information indicating the status of the source dataset may be provided to database manager 232. Database manager 232 may then output the status message to the appropriate display and/or log file of status messages.

At 536, target dataset 252 is renamed to the original file name of the source dataset. At 538, a message may be produced indicating the status of the target dataset (e.g., renamed to original name of source dataset). In at least one embodiment, information indicating the status of the target dataset may be provided to database manager 232. Database manager 232 may then output the status message to the appropriate display and/or log file of status messages.

At 540, the log file of data row migrations may be deleted by I/O gateway 234. In other embodiments, the log file of data row migrations may be deleted after the I/O gateway has stopped running (e.g., by database manager 232), or may be saved for any desired length of time.

At 542, I/O gateway 234 is disconnected from the target dataset and the I/O gateway stops handling user requests or utility process requests. As indicated in FIG. 4B at 420, processing returns to normal for accessing the data tables, which are now stored on target dataset 252. The database manager can establish a connection to the target dataset and user requests to the target dataset can be handled by data processing region of the database manager.

FIG. 6 is a simplified flowchart 600 illustrating at least some of the activities that may be performed by database manager 232 while the I/O gateway 234 is running. It should be noted that the I/O gateway 234 created to re-architect source dataset 242 may be one of multiple I/O gateways created for multiple datasets, respectively, of the database associated with network server 230.

At 602, a user request for access to a data row in a dataset is received. At 604, a determination can be made as to whether the dataset is associated with an I/O gateway. A dataset is associated with an I/O gateway if the dataset is being re-architected by the I/O gateway.

If the requested dataset is not associated with an I/O gateway, then at 606, the user request is processed normally. For example, the user request may be handled through a data processing region created by database manager 232, as shown in FIGS. 3A-3K.

If the requested dataset is associated with an I/O gateway, then at 608, the database manager identifies the I/O gateway that is associated with the dataset. At 610, database manager 232 provides the user request to the identified I/O gateway. Thus, database manager 232 receives user requests and funnels them to the appropriate I/O gateway (if any) to allow the I/O gateway to manage user requests during the migration of data from source dataset 242 to target dataset 252. This process may continue as long as at least one I/O gateway is still running in the database environment.

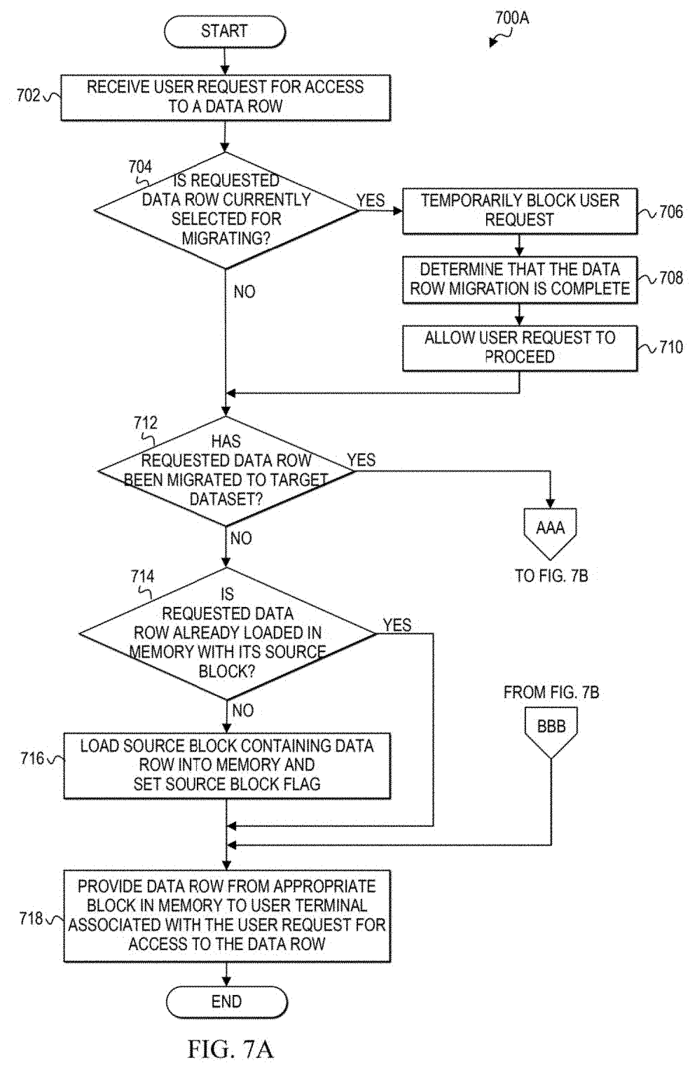

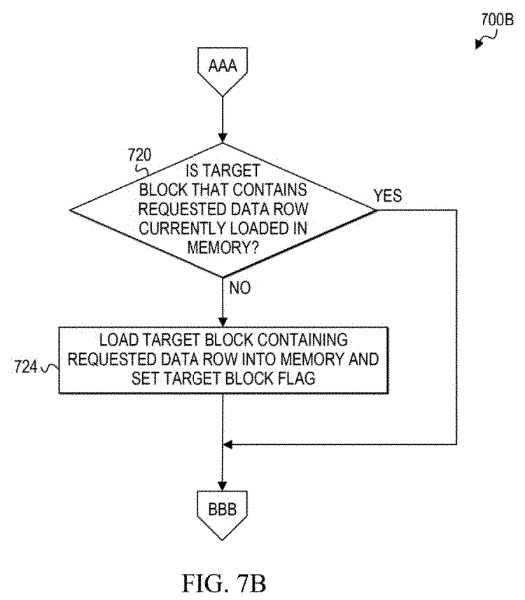

FIGS. 7A-7B are simplified flowcharts 700A and 700B, respectively, illustrating some operations that may be performed by an I/O gateway (e.g., 234) during the architecture change process. Flowcharts 700A and 700B relate to handling user requests for access (read) to data rows in a source dataset (e.g., 242) that are being migrated from the source dataset to a target dataset (e.g., 252) concurrently with the user requests. Access (or read) of a data row typically makes up the majority of user requests.

At 702, I/O gateway 234 receives a user request for access to a data row in source dataset 242 during the migration of its data rows to target dataset 252. At 704, a determination is made as to whether the requested data row is currently selected to be migrated. In some possibly rare scenarios, a user request for access to a data row may happen simultaneously with a background migration process (e.g., 236) selecting the same data row for migration. In this scenario, the user request may be briefly halted until the migration of the requested data row is complete. Accordingly, if the requested data row is currently selected for migrating, then at 706, I/O gateway 234 temporarily blocks the user request. At 708, a determination may be made that the data row migration is complete. At 710, once the data row migration is complete, the user request is processed by the I/O gateway.

At 712, a determination is made as to whether the requested data row has been migrated to the target dataset. In one example, the last migrated key value and the key value of the requested data row can be used to determine whether the requested data row has already been migrated. The last migrated key value can be obtained from a control block of either the source dataset or the target dataset. In one example implementation, if the key value of the requested data row is less than or equal to the last migrated key value, then the requested data row has already been migrated. Conversely, if the key value of the requested data row is greater than the last migrated key value, then the requested data row has not been migrated.

If the requested data row has not been migrated to the target dataset, then at 714, a determination is made as to whether the requested data row is currently in a buffer in memory. The requested data row may be in a buffer in memory with its source block if the data row was previously requested by a user request. The source block is the block of data in the source dataset that contains the data row. For example, if the dataset architecture of the source dataset is defined as 4K byte blocks, then a 4K byte block of data containing the requested data row may be stored in buffer memory if access to the data row was previously requested by a user.

In at least one embodiment, a source block flag (or any other suitable indicator) may be set for each block of the source dataset that is loaded into memory. In this example, at 714, the determination of whether the requested data row is already in memory can be made by determining whether a source block flag is set for the source block that contains the requested data row. If the source block flag is set, then the source block is in memory and therefore, the requested data row is in memory.

If the requested data row is not already loaded in buffer memory, then at 716, a block of data that contains the requested data row is located in the source dataset, retrieved by I/O gateway 234, and loaded into a particular area of memory used by I/O gateway. In addition, a source block flag associated with the source block may be set to indicate that the particular source block has been loaded into memory in response to a user request.

Once the source block containing the requested data row is loaded into memory, or if the source block containing the requested data row was already loaded in memory, at 718, the requested data row from the source block in memory is provided to a user terminal associated with the user request for access to the data row.

With reference again to 712, if the requested data row has already been migrated to target dataset 252, then flow passes to 720 of FIG. 7B. At 720, a determination is made as to whether the requested data row is already in a buffer in memory with the target block that contains the requested data row. The requested data row may be in a buffer in memory with a target block if the requested data row (or any other data row in the target block) was previously requested by a user request after the requested data row was migrated. For example, if the dataset architecture of the target dataset is defined as 27K byte blocks, then a 27K byte block of data containing the requested data row may be stored in buffer memory if access to the requested data row (or any other data row in this 27K byte block) was previously requested by a user after the requested data row was migrated.

In at least one embodiment, a target block flag (or any other suitable indicator) may be set for each block of the target dataset that is loaded into memory. In this example, at 720, the determination of whether the requested data row is already in memory can be made by determining whether a target block flag is set for the target block that contains the requested data row. If the target block flag is set, then the target block is in memory and therefore, the requested data row is in memory.

Even if the requested data row has not been previously requested, the requested data row may be loaded in memory if the target block containing the requested data row is “active.” A target block is “active” if the target block is currently receiving and storing data rows being migrated. If a target block containing a requested data row is active, then the target block may not be filled to capacity and may still have additional space to receive data rows migrating from the source dataset. For example, the active target block may be partially filled (e.g., 20 data rows of 40 possible data rows are stored in the target block). If the I/O gateway receives a user request for access to a data row that has already been migrated to the target dataset and stored in this active target block, which is still in memory, then the user request is processed using this active target block in buffer memory that is already in place.

If the target data block that contains the requested data row is not currently loaded in buffer memory, as determined at 720, then at 724, the target data block containing the requested data row can be located and retrieved from target dataset 252 and loaded into buffer memory. In addition, a target block flag may be set to indicate that the particular target data block has been loaded into memory in response to a user request.

Once the target block that contains the requested data row is loaded in buffer memory, then flow can proceed to 718 in FIG. 7A. At 718, the requested data row from the target block in memory is provided to a user terminal associated with the user request for access to the data row.

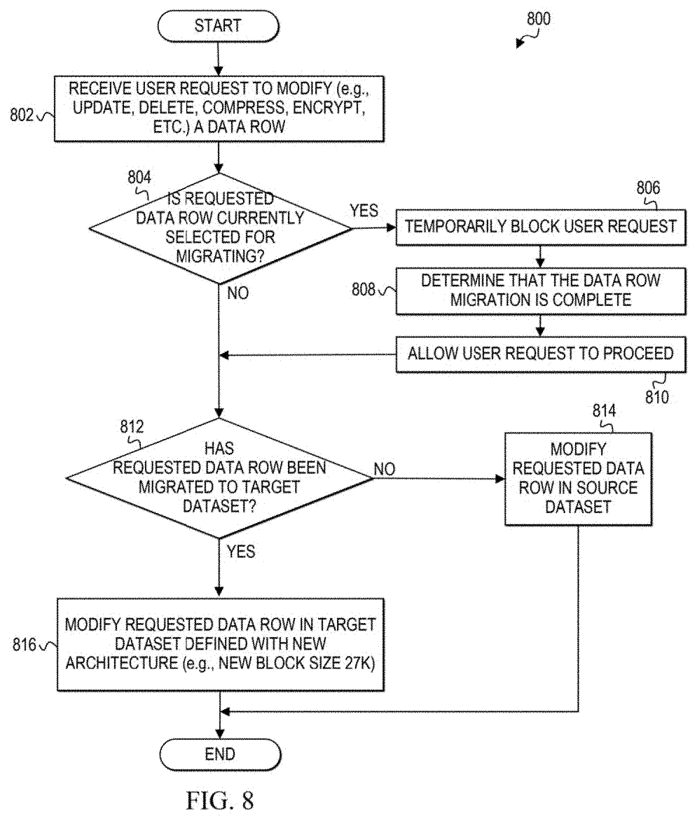

FIG. 8 is a simplified flowchart 800 illustrating some operations that may be performed by an I/O gateway (e.g., 234) during the architecture change process. Flowchart 800 relates to handling user requests to modify data rows in a source dataset (e.g., 242) that are being migrated from the source dataset to a target dataset (e.g., 252) concurrently with the user requests.

At 802, I/O gateway 234 receives a user request to modify a data row in source dataset 242. At 804, a determination is made as to whether the requested data row is currently selected to be migrated. In some possibly rare scenarios, a user request to modify a data row may happen simultaneously with the background migration process (e.g., 236) selecting the same data row for migration. In this scenario, the user request may be temporarily blocked until the requested data row has been migrated. Accordingly, if the requested data row is currently selected for migrating, then at 806, I/O gateway 234 temporarily blocks the user request. At 808, a determination may be made that the data row migration is complete. At 810, once the data row migration is complete, the user request is processed by the I/O gateway.

At 812, a determination is made as to whether the requested data row has been migrated to the target dataset. In one example, the last migrated key value and the key value of the requested data row can be used to determine whether the requested data row has already been migrated. The last migrated key value can be obtained from a control block of either the source dataset or the target dataset. In one example implementation, if the key value of the requested data row is less than or equal to the last migrated key value, then the requested data row has already been migrated. Conversely, if the key value of the requested data row is greater than the last migrated key value, then the requested data row has not been migrated.

If the requested data row has not been migrated from the source dataset to the target dataset, then at 814, the data row is modified in the source dataset based on user access to a source block in memory. In this scenario, the modification can be made based on the same block size in memory and in storage. This is because block size of the source block loaded in memory (e.g., old block size 4K) is the same as the block size defined for the source dataset in the source storage device (e.g., old block size 4K). Modifications of data can include changing the content of the data row, deleting the data row, compressing or decompressing the data row, encrypting the data row, etc.

If the requested data row has already been migrated to the target dataset, as determined at 812, then at 816 the data row contained in a target block loaded in memory (e.g., new block size 27K) is updated based on the new block size. If the data row has been migrated, then the data row is modified in the target dataset even if the modification was requested by a user based on the user accessing the data row via a source block of the source dataset that is loaded in memory.

The internal processing of the user modification request for a data row in the source or target data block size is completely transparent to the user. The database manager in concert with the I/O gateway, manages all aspects of the data block size management and makes the process transparent to the end-user.

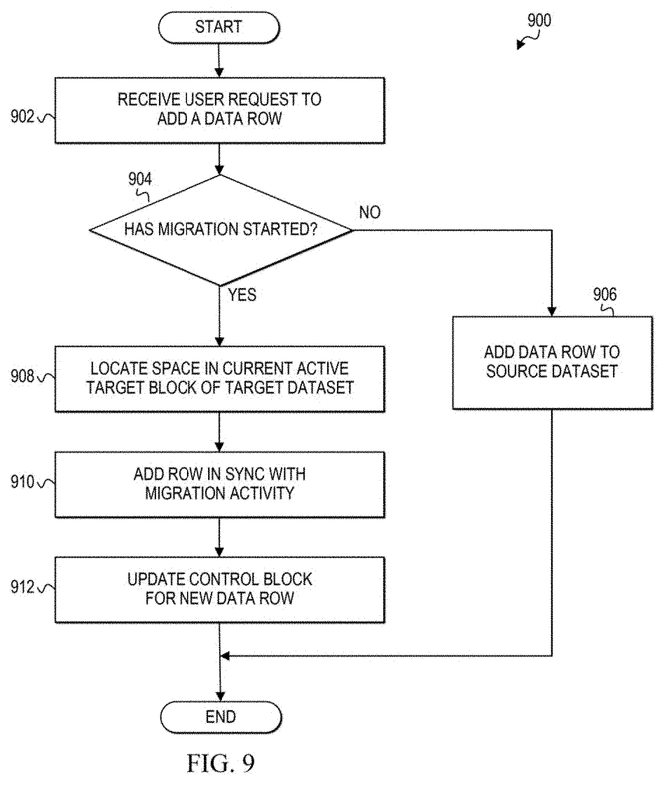

FIG. 9 is a simplified flowchart 900 illustrating some of the data add operations (new rows) that may be performed by an I/O gateway (e.g., 234) during the architecture change process. Flowchart 900 relates to handling user requests to add data rows to a source dataset (e.g., 242) after the migration process to migrate the source dataset to a target dataset (e.g., 252) has been started. If a user request adds a data row once the migration process is started, the I/O gateway directs the addition of the new row to the target dataset. (e.g., 252). This insures that new rows can be added concurrently with the migration process. New rows may be added to the first available space in the active target block. The placement of the new data row may be out of “perfect sequence” with the other data rows, but the small number of adds that typically occur would not substantially affect the overall data row sequence. New data rows that are added during the migration process are tracked by the I/O gateway and the control blocks so that a subsequent request to read or modify the new row (while the migration process is still active) will automatically be directed to the target dataset.

At 902, I/O gateway 234 receives a user request to add a new data row in source dataset 242. At 904, a determination is made as to whether the migration process has been started. If it has not started, then at 906 the data row is added to the source dataset following normal processing procedures.

If the migration process has begun, then at 908, the I/O gateway 234 directs the addition of the new row to the target dataset 252. The I/O gateway 234 finds space in the current active target block and memory for the new data row.

At 910, the new data row is added to the located space in the current active target block and memory. The addition of the new data row by the I/O gateway 234 is synchronized with the migration activity. Synchronizing data row additions with migration activity allows concurrent migrations with data row additions.

At 912, the migration control block is updated (e.g., by a key value associated with the newly added data row) so that any future access requests for this new data row will be directed to the target dataset 252.

FIG. 10 is a simplified flowchart 1000 illustrating some operations that may be performed by a database manager (e.g., 232) during an architecture change process. Flowchart 1000 relates to handling requests from utility processes (e.g., database utility application processes, DBA-initiated processes, other non-end user processes, etc.) to access data rows that are being migrated from a source dataset (e.g., 242) to a target dataset (e.g., 252). In some scenarios, if a utility process request is received for a particular source dataset during an architecture change process of that source dataset, then a database manager (e.g., 232) may block the request. In some other scenarios, if a requested utility process does not conflict with the architecture change process, then the I/O gateway associated with the architecture change process may provide full integration of the utility process with the data row migration. For at least some utility processes, however, the database manager may provide an alternative process that can be integrated by the I/O gateway associated with the architecture change process. In some embodiments, the database manager may send a request to an authorized user (e.g., DBA) to obtain permission to initiate the alternative process. In other embodiments, the database manager may initiate the alternative process automatically. In at least some embodiments, the database manager may issue the alternative process based on whether the alternative process has been pre-authorized to run automatically.

At 1002, a database manager 232 may receive a utility process request that requires access to data of a source dataset (e.g., 242) being re-architected. At 1004, database manager 232 determines whether the requested dataset is currently in an architecture change process. If the requested dataset is not being re-architected, then at 1006, the utility process may be allowed to proceed.

If the requested dataset is currently in an architecture change process, then at 1008, a determination is made as to whether the utility process conflicts with the migration. If the utility process is determined to not conflict with the migration, then at 1010, the utility process is allowed to run and the utility processes that access data rows are handled by the I/O gateway providing full integration with the data row migration.

If the utility process is determined to conflict with the migration, then at 1012, a determination is made as to whether an alternative utility process is available and authorized to run. Determining whether an alternative utility process is authorized to run can include, but is not limited to, requesting authorization from an authorized user (e.g., DBA) or determining whether running the utility has been pre-authorized.

If an alternative utility process is not available or is determined to not be authorized to run, then at 1014, the database manager may block the utility process until the architecture change process is complete.

If an alternative utility process is available and authorized to run during an architecture change process, then at 1016, the database manager can issue a command for I/O gateway 234 to run the alternative utility process.

An alternative utility process can be configured to allow the I/O gateway to integrate the alternative utility process with the background migration process. In one example, the alternative utility process issues requests to access data to the I/O gateway. The I/O gateway receives the utility process requests and, for each request, may use a process similar to flows previously described herein for data access requests (e.g., FIGS. 7A-7B) and for data modification requests (e.g., FIG. 8).

In another example, the I/O gateway may allow the alternative utility process to access data sequentially, as it is migrated to the target dataset. For example, if an alternative backup utility is run by the I/O gateway, then the I/O gateway may establish a connection to a backup storage device, and then provide the alternative backup utility with access to data rows after they are successfully migrated to the target dataset.

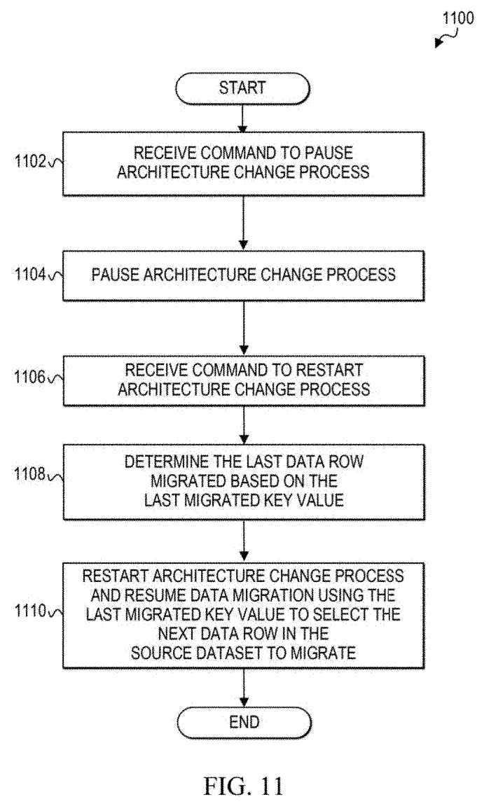

FIG. 11 is a simplified flowchart 1100 illustrating some operations that may be performed by an I/O gateway (e.g., 234) during an architecture change process. Flowchart 1100 relates to handling requests from an authorized user (e.g., DBA) or authorized process to pause the architecture change process. In one example scenario, a very large dataset may take several hours to complete. If a decision is made that another system event (e.g., unscheduled maintenance) must take priority over the architecture change process, then the DBA or other authorized person may issue a command to pause the architecture change process. This may be preferable to allowing the process to crash and then initiating the restart/recovery process using the log file (e.g., 233) once system processing is resumed.

In flowchart 1100, at 1102, the I/O gateway receives a command to pause the architecture change process. In at least some embodiments, the database manager sends this command to the I/O gateway after receiving a command to pause the process from an authorized user or authorized process. In one example scenario, a command to pause the process may be received in order to allow an emergency action to proceed (e.g., stopping and restarting the system). In another example scenario, a DBA may pause the migration process to lessen the load on the database region while another critical process (e.g., billing) completes.

At 1104, the I/O gateway pauses the architecture change process. For example, the I/O gateway stops migrating data rows. The I/O gateway may still process user data requests using the data rows in the source and target datasets. At this point, the DBA (or other system manager) may decide to take the system down and perform the action that triggered the need to pause the architecture change process.

At 1106, once a determination is made to resume system processing (e.g., the unscheduled maintenance is complete), a command is received to restart the architecture change process. For example, the database manager may send the command to restart the architecture change process based on the completion of the system event (e.g., maintenance utility completes) or based on a command from the authorized user or process to restart the architecture change process.

At 1108, the I/O gateway identifies a location in the source dataset where data migration is to resume. In one embodiment, the I/O gateway may retrieve the last migrated key value from the control block of the target dataset and/or the source dataset. The last migrated key value indicates the last data row in a sequence of all data rows in the source dataset that was successfully migrated. The I/O gateway may then select the next data row from the source dataset based on the next key value in the sequence after the last migrated key value. The I/O gateway may resume migration using this selected data row.

The flowcharts and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed sequentially, substantially concurrently, or in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method comprising:
initiating a first migration of data rows in a source dataset in a source storage device to a target dataset in a target storage device, wherein a block size defined for the target dataset is different than a block size defined for the source dataset;
during the first migration, receiving a user request for access to a first data row in the source dataset;
determining that the first data row was migrated to a first target block in the target dataset;
loading the first target block from the target dataset into a first buffer in memory; and
responding to the user request using the first data row in the first target block.

2. The method of claim 1, further comprising:
temporarily blocking the user request based on determining that the first data row is currently selected for migrating; and
responding to the user request after the first data row is migrated to the target dataset.

3. The method claim 1, further comprising:
selecting each data row from the source dataset to be migrated to the target dataset based on a native sequence of the data row in the source dataset.

4. The method claim 1, further comprising:
updating a last migrated key value upon each occurrence of a data row being migrated from the source dataset to the target dataset.

5. The method claim 4, further comprising:
selecting the first data row to be migrated based, at least in part, on a current value of the last migrated key value.

6. The method of claim 1, further comprising:
storing information in a log file, the information related to the data rows that are migrated from the source dataset to the target dataset.

7. The method of claim 1, wherein a device type that defines the source storage device is different than a device type that defines the target storage device.

8. The method of claim 1, further comprising:
during the first migration, receiving a second user request to access a second data row in the source dataset;
determining that the second data row was not migrated to the target dataset;
determining that the second data row is in a source block in the source dataset;
loading the source block from the source dataset into a second buffer in memory; and
responding to the second user request using the second data row in the source block.

9. The method of claim 8, further comprising:
subsequent to loading the source block into the second buffer, migrating the second data row to the target dataset;
receiving a third user request to modify the second data row in the source block;
determining that the second data row was migrated to the target dataset; and
identifying a second target block of the target dataset containing the second data row; and
modifying the second data row in the second target block of the target dataset based on the third user request to modify the second data row in the source block.

10. The method of claim 1, further comprising:
creating, by a database manager executing on a database system, a first gateway to initiate the first migration, wherein the first gateway receives user requests for access to the source dataset.

11. The method of claim 10, further comprising:
subsequent to the first migration completing, removing the first gateway; and
establishing a connection from the database manager to the target dataset.

12. The method of claim 10, further comprising:
creating, by the database manager executing on the database system, a second gateway to initiate a second migration of data rows in a second source dataset in a second source storage device to a second target dataset in a second target storage device,
wherein the second gateway receives user requests for access to the second source dataset, and
wherein the second gateway runs at least partially concurrently with the first gateway.

13. A non-transitory computer readable medium comprising program code that is executable by a computer system to perform operations comprising:
initiating a migration of data rows in a source dataset in a source storage device to a target dataset in a target storage device, wherein a block size defined for the target dataset is different than a block size defined for the source dataset;
during the migration, receiving a user request to modify a first data row in the source dataset;
determining that the first data row was migrated to the target dataset;
identifying the first data row in a first target block of the target dataset; and
modifying the first data row in the first target block of the target dataset based on the user request to modify the first data row in a source block of the source dataset.

14. The non-transitory computer readable medium of claim 13, wherein the program code is executable by the computer system to perform further operations comprising:
temporarily blocking the user request based on determining that the first data row is currently selected for migrating; and
responding to the user request after the first data row is migrated, wherein the responding includes the modifying of the first data row in the first target block of the target dataset.

15. The non-transitory computer readable medium of claim 13, wherein the program code is executable by the computer system to perform further operations comprising:
updating a last migrated key value upon each occurrence of a data row being migrated from the source dataset to the target dataset; and
selecting the first data row to be migrated based, at least in part, on a current value of the last migrated key value.

16. The non-transitory computer readable medium of claim 13, wherein the program code is executable by the computer system to perform further operations comprising:
receiving a user request to add a second data row to the source dataset;
adding the second data row to an active target block of the target dataset;
identifying a next data row in the source dataset to be migrated to the target dataset; and
migrating the identified next data row from the source dataset to the active target block of the target dataset.

17. An apparatus comprising:
a processor;
a memory coupled to the processor; and
a database manager including instructions that are executable by the processor to:
create a first gateway executable by the processor to change an architecture of a source dataset in a source storage device, the first gateway to:
initiate a first migration of data rows in the source dataset to a target dataset in a target storage device, wherein a block size defined for the target dataset is different than a block size defined for the source dataset;
during the first migration, receive a user request for access to a data row in a source block of the source dataset;
determine that the data row was not migrated to the target dataset;
load the source block into a first buffer in memory; and
respond to the user request using the data row in the source block.

18. The apparatus of claim 17, wherein the first gateway is to further:
subsequent to loading the source block into the first buffer, receive a second user request to modify the data row in the source block;
determine that the data row was migrated to the target dataset;
identify a target block of the target dataset containing the data row; and
modify the data row in the target block of the target dataset based on the second user request to modify the data row in the source block.

19. The apparatus of claim 17, wherein the instructions that are executable by the processor are to further:
during the migration, receive a utility process request to access the source dataset;
block the utility process; and
instruct the first gateway to perform an alternative utility process, wherein the first gateway is to control accesses by the alternative utility process to the source dataset and the target dataset.

20. The apparatus of claim 17, wherein the instructions that are executable by the processor are to further:
create a second gateway to change an architecture of a second source dataset in a second source storage device, wherein the second gateway is to:
initiate a second migration of data rows in the second source dataset to a second target dataset in a second target storage device, wherein the second gateway is to run at least partially concurrently with the first gateway.
